(19) United States
(12) Patent Application Publication
(10) Pub. No.: US 2019/0347620 A1
(43) Pub. Date: Nov. 14, 2019

(54) COMPUTER-IMPLEMENTED METHOD AND SYSTEM FOR MANAGING CHILD CARE SERVICES IN REAL-TIME

(71) Applicant: Hon Trang, Calgary (CA)

(72) Inventor: Hon Trang, Calgary (CA)

(21) Appl. No.: 15/974,152

(22) Filed: May 8, 2018

(51) Int. Cl. G06Q 10/10; G06Q 50/20

(52) U.S. Cl. CPC G06Q 10/1093; G06Q 50/205

(57) ABSTRACT

A computer-implemented method and system for managing child care services in real-time. In various embodiments, the method and system manage the availability of a group of qualified Child Care Businesses (e.g. Child Care Centers, Family Child Care Homes and Child Care for Children with Special Needs) in a specific geographic area, offer the child care services in real-time to any user of the platform and efficiently manage its resources while providing high quality services. Users have the ability to review the characteristics of the Child Care Businesses in the system, confirm whether they are aligned with their expectations as a parent and consumer, review the availability of a specific center that matches what they are looking for and, ultimately, book the Child Care services based on their needs and location availability.

### FIELD OF THE INVENTION

The present invention relates to a computer system and method for real-time child care service scheduling.

### BACKGROUND OF THE INVENTION

Nowadays, there is a need in the market for a solution to connect child care businesses with parents that require their services as well as child care businesses with early childhood educators, child care workers and/or educators for children with special needs. There is no system, solution or method that presently provides the adequate framework or environment to support the proper engagement of the parties involved in the process of child care services supply.

Parents Perspective

Parents go through a cumbersome and time-consuming process to find entities that will provide them with the necessary child care services, either on a one-time basis or permanently. A high percentage of families today require child care services on a daily-basis, parents or guardians that travel may require these services outside their usual location or families with a stay-at-home parent may require this type of services sporadically for emergency situations or events that are not suitable for minors. A business trip for a single parent, a funeral, an accident, a visit to a hospital, a doctor's appointment, an unexpected event, or last-minute errand are just some examples of these situations in which non-permanent child care services might be required.

Focusing on parents that require child care services daily, we find that identifying the right place and team that will take care of the child or children is not an easy task. Most of the time parents spend an excessive number of hours researching the child care businesses available in their geographic area. This research is usually performed as a combination of online searches, phone calls and in-person visits to each of the locations since there is a considerable number of variables that need to be considered. Some of these variables include the location of the child care business, and the type of child care business (i.e., child care center, family child care home, or child care for children with special needs), business license or qualification.

Additional variables that parents often consider are monthly or drop-in fees that vary depending on the child's age and needs, quality of the facility, quality of meals, operating procedures (i.e., whether the child care center perform background checks as part of its hiring process, the minimum education level for the educators, educator turnover rate, etc.). Further, the child care center's safety and security policies and procedures, drop-in and pick-up procedures, emergency procedures, sick procedures, parent or guardian contact procedures, and field trip procedures are also considered by parents.

The foregoing is just an example of all the variables that need to be taken into consideration and how complex the selection process is for a parent. In addition, parents not only have to consider the complex logistics associated to the child care services but also the emotional stress and anxiety associated with anything related to kids and the ultimate parents' goal of providing to their children the best services that they can afford.

Focusing on stay-at-home parents that require child care services on a one-time basis, we find that the need for child care services is not always predictable and therefore the parents struggle to find the right child care business that can accept a child as a drop-in or even as a last-minute request in an emergency. Some parents have the chance to resort to family members, friends or babysitting services in these cases, but others don't have this type of support. Other parents prefer a safe place for their kids to play and learn together with other children in a more structured approach such as the one provided by child care businesses instead of just resorting to plain babysitting support. In both scenarios, parents require an immediate response from child care businesses that is not possible today with the current systems and engagement methods. It's also worth noting that these parents not only have to deal with the stress associated with the unexpected event, but they also must find someone trustworthy to take care of the child or children as needed in a very limited time.

Finally, we should also consider the impact that a more globalized society has in parents' lives today. An increasing number of parents work for global companies that have offices all over North America or all over the world. Ability to travel is a must in many of these companies' positions and not all the families have the proper support framework from a second parent, other family members or friends that can take care of the child or children during these business trips. Having to find child care businesses in a city or even country different from our usual location is a huge problem that has not been properly addressed today. The necessary effort to arrange these services in an unknown environment is exponential; therefore, making the ability to travel a real challenge or an impossible task even for some parents.

Child Care Business Perspective

Child care businesses are presently facing numerous challenges considering the lack of tools and methods to support them today. One of these issues relates to their inability to maximize the utilization of their resources. In an ideal situation, a child care business owner or director would like to have 100% occupancy and ensure that their resources' utilization (early childhood educators, child care workers and educators for children with special needs) is maximized based on the child/educator ratio per age range defined by regulation entities. However, factors such as drop-ins, cancellations, new registrations, sick kids, parents' vacations, among others, are just some examples of the variables that play a critical role in this resource allocation task, preventing child care businesses to predict the exact number of children that will attend to their facilities and therefore maximizing their occupancy without the risk of overbooking.

In addition, as previously mentioned, the main resource of a child care facility is the educator and, based on regulations, there is a maximum child/educator ratio per age range that is permitted at any given time. However, unexpected situations may arise preventing educators to go to work. Sickness, accidents or family issues are just some examples that happen often and impact the child care businesses operations. The only available solution to this problem is to have some floating staff in the child care business payroll that will take over when an absence occurs. However, this solution just increases the inefficiency of child care businesses and reduces the utilization of the educators in their payroll. It is also important to highlight that child care businesses don't usually have more than 1 or 2 floating staff members. As a result, there might be situations in which child care businesses won't comply with the maximum child/educator ratio per age range when a high number of their educators are absent.

Finding the right educator to be recruited permanently or to support temporary staffing needs is not an easy task for a child care business. There are different relevant factors when choosing the right educator based on the specific needs of the business: experience of the educator, background check and police clearance information, credentials and education (bachelor's degree in early childhood education, child care worker experience, early learning childhood certificate, behavioral/developmental aide education, etc.), salary expectations, and references from previous jobs.

Based on the information published by the USA Bureau of Labor Statistics (BLS) and the NCES (National Center for Education Statistics), the unemployment rate for early childhood educators in 2015 was only 1.0% (1) and growth employment expectations for child care workers between 2016 and 2026 is a 7% (2). Based on these data, we can conclude that being able to find early childhood educators that are available to support a child care business's staffing needs will be a challenge in the coming years.

It is also worth noting that finding the right educator is paramount to the success of a child care business since there is always a training period associated to a new recruitment and therefore, having high turnover in the staff impacts their operations and efficiency.

Finally, having the ability to reach out to the community members of the area where the child care business is located is crucial for them to increase their clientele and revenue. Child care businesses use different methods to reach out to the community and potential users of their services but there is not a specific platform today specialized in exclusively advertising child care businesses services and supporting their engagement with parents.

Educator Perspective

Early childhood educators, child care workers or educators for children with special needs find their jobs by using the existing job posting platforms (e.g. newspaper ads, internet search engines, job posts in the child care businesses website, generic job posting websites). Therefore, the information that they have about the child care business open position that they are applying to is very limited.

Like any other position in the market, finding the right child care business to work for is a matter of doing a lot of research, having several interviews with child care businesses' owners or directors and hoping that the vision and culture of that specific business is aligned with the educator's vision and expectations. In some cases, finding the right business is a matter of trial and error and that not only impacts the educator but also the quality of the services provided by the child care businesses by increasing their staff turnover.

Accordingly, there is a need and desire for a computer system and method for managing availability of a group of qualified child care businesses (e.g. child care centers, family child care homes and child care for children with special needs) in a specific geographic area, offer child care services in real time to any user of the platform and efficiently manage its resources while providing high quality services.

### SUMMARY OF THE INVENTION

Embodiments of the present invention address the foregoing needs by providing a system and method that child care businesses can use to offer their available unused spots in a daily basis. By doing that, the businesses will maximize their capacity and the utilization of their resources.

In embodiments of the invention a calendar associated to each child care business indicating the number of spots that they have available per child age (e.g. infants, younger toddlers, older toddlers, preschoolers, after school care spots) is displayed in real-time. Parents with the need for these services, either long term or short term, will review the calendar and availability of the selected businesses and will be able to book the spots in real-time. The availability and calendar of the child care business will be updated in the system and readily available for other parents/consumers to review and book any left spots. Embodiments of the invention will also support last-minute services requests (less than 24 hours in advance).

In embodiments of the invention, every child care business will have to be registered before they can use the system. To guarantee that only qualified businesses are included in the system, they will be vetted through a background, qualifications and licensing check. If the child care business does not meet the minimum standards for excellence that have been defined for each type of child care business (e.g., child care centers, family child care homes and child care centers for children with special needs), the registration request of the child care business will be rejected and they won't be able to advertise their services nor offer their available spots to the parents/consumers. Parents will also have to be registered in the system for them to use the platform but there is no specific minimum requirement for them to be approved as a user/consumer.

In embodiments of the invention, parents will have the ability to access the profile and information of all the child care businesses that are registered in the platform and easily determine the best child care centers, family child care homes and child care centers for children with special needs that meets their needs. The number of child care businesses registered in the system are unlimited therefore the parents will have the ability to use a group of filters to narrow down their search (e.g. location, characteristics of the facilities, services provided, rates, availability in a specific date).

In embodiments of the invention, once parents use the platform to book child care services, they will also have the option to provide feedback and score the quality of the child care services received. This score and feedback will be public and readily available to other users of the platform. This scoring and feedback will be extremely valuable because it will prevent that low-quality child care services are overlooked by other members/users of the platform. Those businesses that provide high-quality services will be rewarded with higher scoring and better feedback which will eventually bring them more business.

In embodiment of the invention, the scoring will be weighted in such a way that the feedback of users with more seniority (i.e., parents that have booked more child care services through the system) is a feedback that will ponder more than the feedback from other parents with less seniority. This weighted score is just one of the multiples embodiments that this scoring may have.

Embodiments of the invention also pertain to engagement of early childhood educators, child care workers and educators for children with special needs with child care businesses. As previously stated, having the ability to find the right educator resources in a timely manner is crucial for the success of a child care business. Whether the engagement of these two parties is just temporary to supply a short-term staffing need or permanent (i.e., addition of the educator to the business payroll), embodiments of the invention provide the right environment for them to define the engagement terms and make sure that both parties comply accordingly with them.

Embodiments of the invention show a calendar associated to each educator indicating their availability and a profile with their experience and qualifications. Like the parent-business engagement system and method, child care businesses with the need of an educator, either long term or short term, will select the educator or educators that meet their needs (e.g., characteristics and availability) and will have the chance to submit an offer in real time. The educators will receive the offers, review it and have the chance to accept it or submit a counteroffer to the businesses. The availability and calendar of the educators will be updated in real-time in the system. Embodiments of the invention will also support last-minute work engagements (less than 24 hours in advance).

Likewise, the educators will have to be registered for them to advertise their services, skills and availability through the system. Once the educator requests his or her registration, the system will also run a background and qualifications check and confirm whether the educator meets the minimum requirements to be part of the platform. On the one hand, if the educator does not comply with these requirements, the educator's registration request will be rejected, and the educator will not have the ability to use the platform as an educator. On the other hand, if the educator is qualified and the registration is accepted, educators will become members of a pool of specialized child care floating resources, namely Employee Pool On Demand, also known as the ePOND. The ePOND will support any on-demand staff needs of the Child Care Business in the system at any given time.

Once engagement between a child care business and an educator ends, both the child care business and the educator will have the option to score their experience. It is worth noting that this scoring of the child care business will be managed separately from the scoring provided by parents. There is a marked difference between the quality of a child care business as a service provider and the quality of a child care business as an employer and therefore the two scoring systems will be managed independently.

In general, in one aspect, a computer-implemented data processing method for scheduling child care services in real-time is provided. The data processing method comprising:
(a) receiving, by one or more computer processors, a command to create an electronic record for a child care service by a first user;
(b) creating, by one or more computer processors, an electronic record for the child care service and digitally storing the record;
(c) receiving, by one or more computer processors, child care service data input by the first user, wherein the child care service data comprises each of:
   identification of a second user;
   time and date of child care service; and
   a response due date;
(d) processing, by one or more computer processors, the child care service data by electronically associating the child care service data with the record for the child care service;
(e) digitally storing, by one or more computer processors, the child care service data in association with the child care service record;
(f) creating, by one or more computer processors, based at least in part on the received child care service data, an availability data record of the second user;
(g) processing, by one or more computer processors, the availability data record of the second user by electronically associating the availability data record of the second user to the record for the child care service;
(h) determining, by one or more computer processors, based at least in part on the received child care service data and the availability data record of the second user, whether child care services are available by the second user and creating a message flag based on the determination; and
(i) sending, by one or more computer processors, an electronic message, based at least in part on the message flag, to the first user.

In general, in other aspects, the data processing method further comprises:
receiving, by one or more computer processors, a request to modify the child care service data; and
in response to receiving the request, determining, by one or more computer processors, whether the child care service data is modifiable.

In general, in other aspects, the data processing method further comprises:
receiving an electronic confirmation that child care services, made according to the child care service data and the availability data record, has been completed;
receiving, by one or more computer processors, child care service quality data input by the first user, wherein the child care service quality data comprises a rating indicator of the child care services performed by the second user;
digitally storing, by one or more computer processors, the child care services quality data in association with the electronic record for the child care services;
electronically determining a weighting factor for the rating indicator, by one or more computer processors, that is based at least in part on a number of times the first user has completed child care services; and
in response to determining a weighting factor, modifying, by one or more computer processors, a profile record of the second user to reflect the weighting factor.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic illustration of various users of a system and method according to an embodiment of the present invention;

FIG. 2 is a diagrammatic illustration of a child care services management system according to an embodiment of the present invention;

FIG. 3 is a diagram illustrating various functions or operations available to a Child Care Business user according to an embodiment of the present invention;

FIG. 4 is a diagram illustrating various functions or operations available to a Parent or Guardian user according to an embodiment of the present invention;

FIG. 5 is a diagram illustrating various functions or operations available to an Educator user according to an embodiment of the present invention;

FIGS. 6a and 6b illustrate a process-flow diagram for registering a Child Care Business user according to an embodiment of the present invention;

FIG. 7 illustrates a process-flow diagram for registering a Parent or Guardian user according to an embodiment of the present invention;

FIGS. 8a and 8b illustrate a process-flow diagram for registering an Educator user according to an embodiment of the present invention;

FIGS. 9a through 9c illustrate a process-flow diagram for managing a profile of a Child Care Business user according to an embodiment of the present invention;

FIG. 10 illustrates a process-flow diagram for managing a profile of a Parent or Guardian user according to an embodiment of the present invention;

FIGS. 11a through 11c illustrate a process-flow diagram for managing a profile of an Educator user according to an embodiment of the present invention;

FIG. 12 illustrates a process-flow diagram for managing or monitoring the credentials or licenses of a Child Care Business user according to an embodiment of the present invention;

FIG. 13 illustrates a process-flow diagram for managing or monitoring the credentials or licenses of an Educator user according to an embodiment of the present invention;

FIG. 14 illustrates an example Availability Calendar of a Child Care Business user according to an embodiment of the present invention;

FIG. 15 illustrates an example Availability Calendar of an Educator user according to an embodiment of the present invention;

FIG. 16 illustrates a process-flow diagram for a Parent/Guardian or Educator user to search for Child Care Business users according to an embodiment of the present invention;

FIG. 17 illustrates a process-flow diagram for a Child Care Business user to search for an Educator user according to an embodiment of the present invention;

FIG. 18 illustrates a process-flow diagram of a parent request of child care services according to an embodiment of the present invention;

FIG. 19 illustrates a process-flow diagram of a Child Care Business request of Educator services according to an embodiment of the present invention;

FIG. 20 illustrates a process-flow diagram of a user service modification request according to an embodiment of the present invention;

FIG. 21 illustrates a process-flow diagram of a user service cancelation request according to an embodiment of the present invention;

FIG. 22 illustrates a process-flow diagram of an emergency service request according to an embodiment of the present invention;

FIG. 23 illustrates a process-flow diagram of an emergency service modification request according to an embodiment of the present invention;

FIG. 24 illustrates a process-flow diagram of an emergency service cancelation request according to an embodiment of the present invention;

FIG. 25 illustrates representation of a User Experience Rating and Feedback Interface according to an embodiment of the present invention;

FIG. 26 is a schematic diagram of a computer that is suitable for use in various embodiments of the present invention.

### DETAILED DESCRIPTION OF THE INVENTION

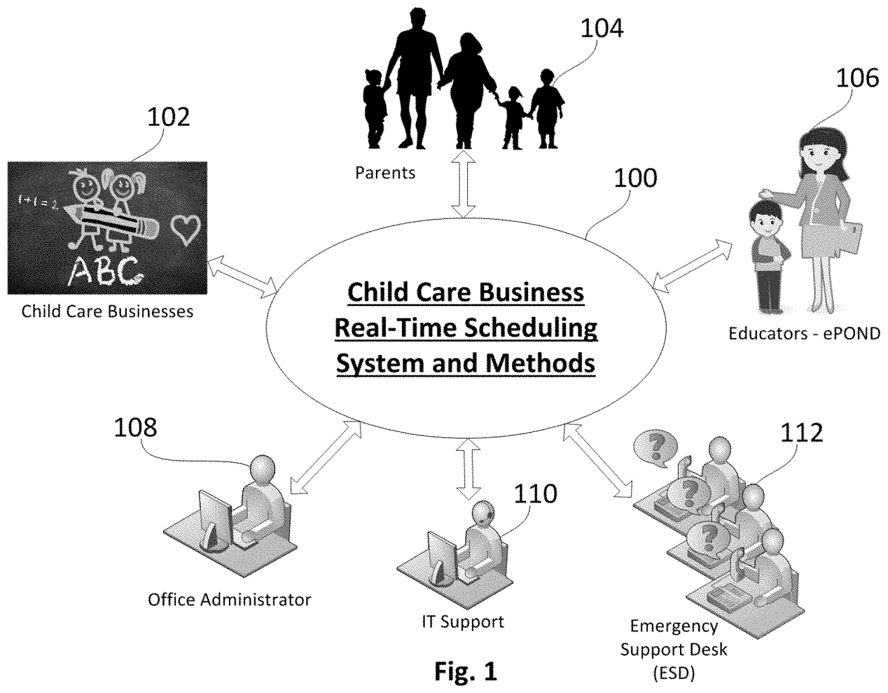

With reference to FIG. 1, there is diagrammatically illustrated various users of the system 100 of the present invention. Specifically, there are front-end users of the system 100 that include child care businesses 102, parents or guardians 104, and educators 106. There are also back-end users of the system 100 that include office administrators 108, IT support 110 members, and emergency support desk members 112.

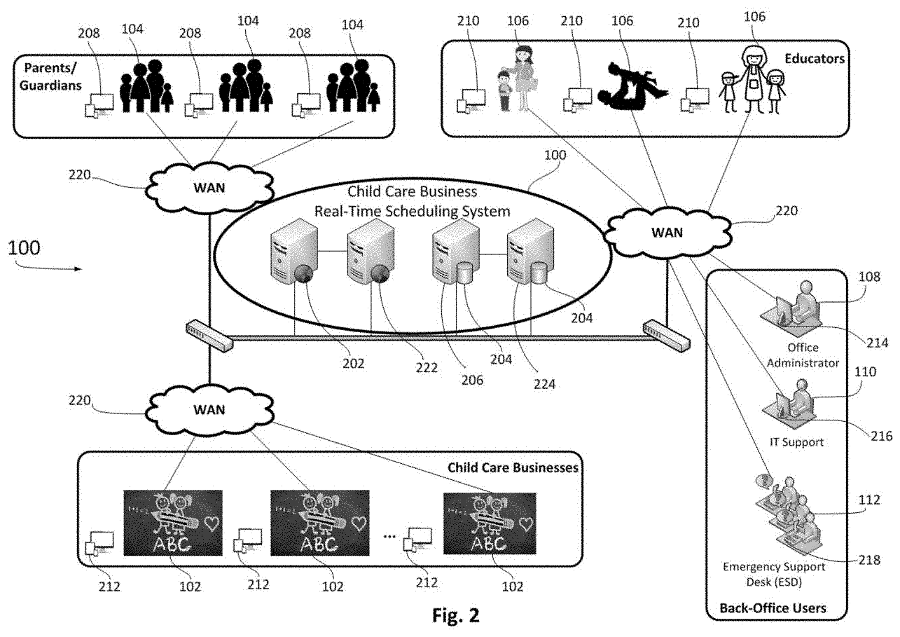

Referring to FIG. 2, a system for managing child care services is generally indicated by reference number 100. System 100 uses web-application technology this is hosted or run on web or application servers 202 that have accesses to information database 204 that can include registered user profiles and that can be located on the application servers or located on database servers 206. The system 100 further includes computing devices 208 that are associated with parents or guardians 104, computing devices 210 that are associated with educators 106, computing devices 212 that are associated with child care businesses 102, computing devices 214 that are associated with office administrators 108, computing devices 216 that are associated with IT support members 110 and computing devices 218 that are associated with emergency support desk members 112. All the computing devices may include one or more of desk top computers, laptop computers, smart phones, mobile computing devices, tablet computers, etc. that are able to either execute a software locally stored and/or access web-browsers to execute web-based applications.

Computing devices 208-218, web/application servers 202, and database servers 204 communicate through network 220. Network 220 can be any data network and may include a mixture of different data network types. For example, network 220 may include the internet which is accessibly via a WAN, LAN, cellular network, etc. by any number of data connections, for example hardline, wireless, WiFi, radio, etc.

In addition, to ensure that the information in the database or web server won't be lost in case that a technical issue arises, the system will be set up in a “Hot/Stand-by” configuration. A “Hot/Stand-by” configuration means that each server (Web Server and Database server) will have a copy with the exact same data that they have, providing redundancy and security to the overall architecture of the solution. The “Hot” servers will be the primary servers and the “Stand-by” servers will be used only when the “Hot” servers are not available. The users of the invention will connect to the “Hot” Web Server 202 to perform the different tasks/methods in the platform and this server will access the “Hot” Database Server 204 to gather the latest information.

If a failure occurs in one of the “Hot” servers, the invention will automatically switch to the “Stand-by” Server (Webserver or Database Server, depending on which one stopped working properly) 222 and, 224, respectively, and the system will continue functioning with no interruptions to the service. The IT support team will oversee resolving the underlying problem and the system will go back to its normal Hot/Stand-by configuration. All these Hot/Stand-by processes will be performed in the background, completely transparent to the front-end users.

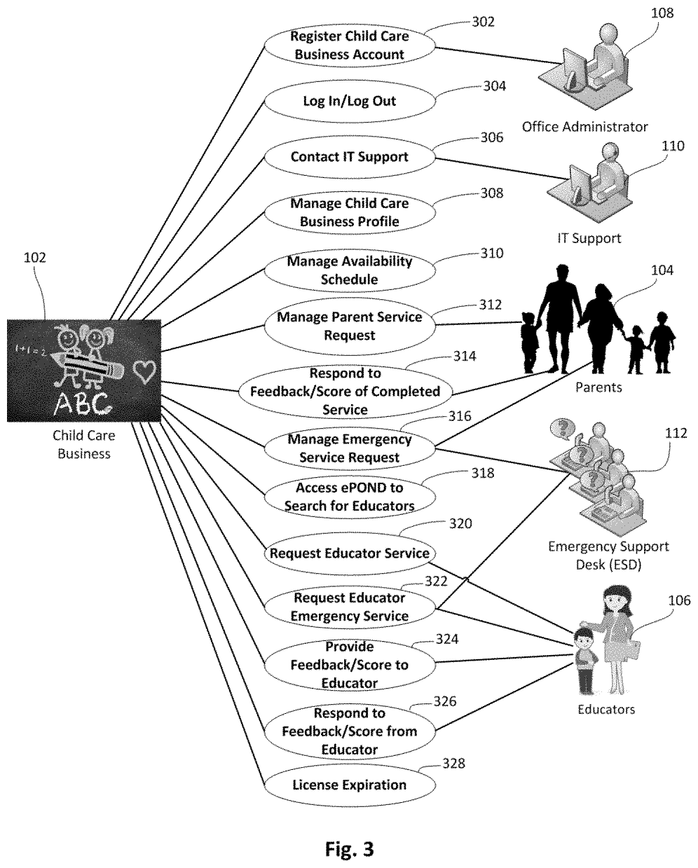

Different user types will have different application tasks available for execution by the computing devices. With reference to FIG. 3, there is diagrammatically shown various application tasks available to child care business users 102 to engage with the various other system users. As shown in the representative embodiment, child care business users 102 have register a child care business account application task 302. Here the software operates to execute task or operation 302 to register a child care business account with the system 100. The child care business will have to register the account for them to be able to use the system and offer their services. The child care business will provide all the details about their facilities and qualifications and a background check and credentials/licensing check will be performed by the office administrator before the child care business is accepted. None of the other operations or functions shown in FIG. 3 will be available until the child care business has been properly vetted and the assessment is positive.

Operation 304—log-in/log-out: Once the child care business has been vetted and has a validated account, they will be able to log in to the system to perform any other activity or log out/disconnect.

Operation 306—Technical issue/contact technical support: If the child care business has technical difficulties with their profile or the platform, they have the option to contact the technical support (IT Support) to get those issues resolved.

Operation 308—Child Care Business Profile Management: Every child care business account will have a profile with all the details associated to them. The child care business can update and modify their profile at any time. A full description of the different fields that will be available in the profile is discussed below.

Operation 310—Manage Availability Schedule: The child care business will offer its available spots and the age range for those spots using a real-time scheduling method. This schedule will be automatically updated every time that any available spot is booked through the platform or can be updated manually by the child care business administrator/director at any time. Showing a current picture of the child care business availability is crucial for their success and to help them maximize the occupancy and utilization of its resources.

Operation 312—Manage Parent Service Request: Once the child care business has published the schedule with the available spots and the age range, parents will have the option to use this invention to launch child care services requests to the child care businesses. The child care Business will receive an alert with the request (e.g., email, text, web application notification) and they will decide whether they want to accept it or not and will double check that they have availability to supply the child care services on that specific date.

Operation 314—Respond to Feedback/Score of Completed Service: Once the child care services have been supplied, the parents can provide feedback and score the quality of the received services. This invention acknowledges that the feedback and score have a subjective component and therefore the child care business has the chance to respond to any feedback (positive, neutral or negative) that they may have received. That response will provide some perspective to any other consumer/parent that reviews previous experiences of other users with that specific child care business. In subsequent sections a full description of the scoring system and method will be provided.

Operation 316—Manage Emergency Service Request: In those cases that the parents have launched a child care service request within less than 24 hours, the emergency request method will be used and the Emergency Support Desk (ESD) will support the parents and the child care business during the booking process to ensure that the request is reviewed and confirmed in a timely manner.

Operation 318—Access ePOND to Search for Educators: As already mentioned in previous sections, once the educators have been properly vetted and have been registered in the platform, they are included into the Employee Pool On Demand (ePOND). Registered child care businesses can access the ePOND at any time and review the profile of any educator within the pool. This function is extremely valuable when looking for permanent employees that will be added to the child care business payroll but can be also used when looking for floating resources to meet a short-term staffing need.

Operation 320—Request Educator Service: Educators that are included in the ePOND will have a calendar associated to educator's profile that shows the educator's availability. Child care businesses will have the option to determine the right educators based on their qualifications, availability and needs and send an educator service request through the system to the selected educator. The educator will review the characteristics of the service request (dates, child care business, labor rate, etc.) and can accept or decline the offer.

Operation 322—Request Educator Emergency Service: In those cases in which the Child Care Business requires Educator services within less than 24 hours, the emergency request process will be followed and the Emergency Support Desk (ESD) will support the Child Care Businesses in facilitating the communication and engagement with the Educators to ensure that the request is reviewed and confirmed in a timely manner.

Operation 324—Provide Feedback/Score to Educator: Once the Educator and Child Care Business engagement has finalized and the services have been supplied, both the Child Care Business and the Educator will have the option to provide feedback and score the quality of the engagement with the other party involved in the transaction.

Operation 326—Respond to Feedback/Score from Educator—Like the function related to Parents feedback/score, the Child Care Business will have the chance to respond to any feedback (positive, neutral or negative) that they receive from Educators. That response will provide the Child Care Business perspective to any other Educator user in the system.

Operation 328—License Expiration: This system 100 operates to monitor the validity of the child care business credentials. The Child Care Business Credentials have an expiry date and the system will enforce that those credentials are properly validated before they are obsolete.

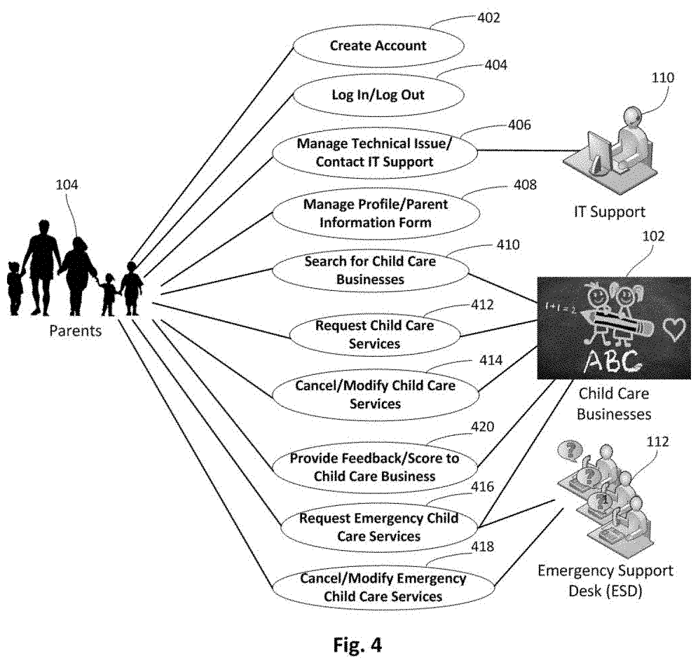

In FIG. 4, there is diagrammatically shown various application tasks available to parent users 104 to engage with the various other system users. The following outlines the various operation functions or tasks for parent users:

Operation 402—Create Account: The Parents will have to register and create an account for them to be able to use the platform and enjoy the available Child Care Services. Parents will provide personal details, such as contact information, number of kids that would use the Child Care facilities and their ages. In addition, optionally, they can also indicate their preferences and what they are looking for in a Child Care Business. The more information they provide about their preferences, the easier it will be for the system to filter the Child Care businesses that comply with the minimum requirements that the parents are looking for. Parents won't be required to go through any type of background check since they don't need any qualification whatsoever to enjoy the platform and its services. A full description of the registration process is included in subsequent sections.

Operation 404—Log-in/Log-out: Once the Parents have created the account, they will be able to log in to the system to perform any other activity or log out/disconnect.

Operation 406—Manage Technical Issue/Contact Technical Support: If a Parent has technical difficulties with their profile or the platform, they have the option to contact the technical support (IT Support) to get those issues resolved.

Operation 408—Manage Profile/Parent Information Form: Every Parent account will have a profile with all the details associated to them. Those details include the information provided when they created the account (e.g. name, location, number of kids and their ages, among others), the parents' preferences and the “Parent Information Form”. The Parent Information Form is a form that includes all the vital information that a Child Care Business requires for them to properly take care of a child. In this form they will provide critical details such as family/contact information, emergency contact information, immunization status, allergies, child medical insurance coverage, consent to medical care and treatment if something happens, consent to video and pictures, consent to outdoor activities and walks, among others. It is important to highlight that the “Parent Information Form” won't be required when creating the account so that the registration process is simple and friendly, but it will be necessary to book any Child Care Services through the platform.

Operation 410—Search for Child Care Businesses: Parents will have the option to go into the system and select those Child Care Businesses that better meet their needs based on their preferences and other specific filters. Having the ability to filter businesses based on specific parameters and review their availability, score or other parents feedback is a very powerful tool for parents when looking for permanent Child Care services.

Operation 412—Request Child Care Services: Once the Child Care Business has published the schedule with the available spots and the age range, Parents will have the option to use this invention to request Child Care Services to a Businesses that meet the Parent's needs. The Child Care Business will confirm their availability and accept or reject the request accordingly.

Operation 414—Cancel/Modify Child Care Services: There might be cases in which the Parents need to Cancel a Child Care Service that has already been booked through the system. The exact process and consequences (if any) for canceling or modifying the booked services is described below.

Operation 416—Request Emergency Child Care Services: In cases where the Parents require Child Care services within the next 24 hours. In these cases, the emergency request method will be used and the Emergency Support Desk (ESD) will support the Parents and the Child Care Business during the booking process to ensure that the request is reviewed and confirmed in a timely manner.

Operation 418—Cancel/Modify Emergency Child Care Services: Like the process associated to Canceling or Modifying normal Child Care Services, in this operation, the Emergency Support Desk (ESD) will have to be involved since we need any modification or cancellation to be notified to the involved parties right away.

Operation 420—Provide Feedback/Score to Child Care Businesses: Once the parents and child care business engagement has finalized and the services have been supplied, the Parents will have the option to provide feedback and score the quality of the engagement with the other parties involved.

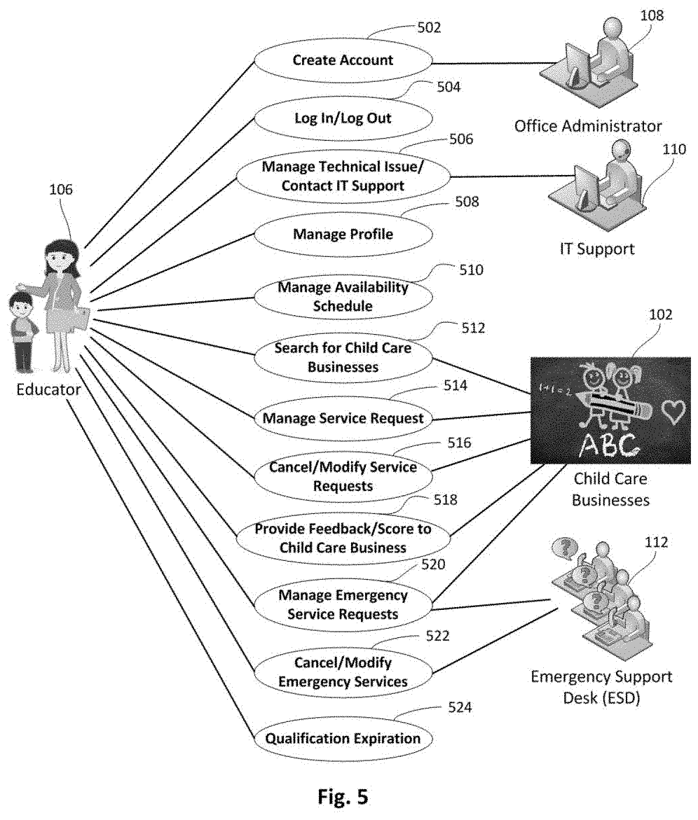

In FIG. 5, there is diagrammatically shown various application tasks available to educator users 106 to engage with the various other system users. The following outlines the various operation functions or tasks for parent users:

Operation 502—Create Account: Educators will have to register their account for them to be able to use the platform and offer their services. The Educator will provide all the details about their experience, qualifications and certifications and, in addition, a background check and credentials check will be performed by the Office Administrator before the Educator is accepted and the account is created. None of the illustrated functions will be available until the Educator has been properly vetted and the assessment is positive. Only qualified Educators will be approved.

Operation 504—Log-in/Log-Out: Once the Educators have created the account, they will be able to log in to the system to perform any other activity or log out/disconnect.

Operation 506—Manage Technical Issue/Contact Technical Support: If the educator experiences technical difficulties with their profile or the platform, they have the option to contact the technical support (IT Support) to get those issues resolved.

Operation 508—Manage Educator Profile: Every Educator account will have a profile with all the details associated to them. The Educator will have the ability to update and modify their profile at any time.

Operation 510—Manage Availability Schedule: The Educator will be able to include his/her availability per day in their schedule. Once the Educator schedule is set up, Child Care Businesses will be able to book the Educators services using the Real Time Scheduling method. The Educator's schedule will be automatically updated every time a Child Care Business books any of the Educator's open spots through the platform. The Educators can always update their own schedule at any given time.

Operation 512—Search for Child Care Business: Educators will have the option to go into the system and select those Child Care Businesses that better meet their needs based on their preferences and what they are looking for. Having the ability to filter businesses based on specific parameters and review their availability, score or other parents feedback is a very powerful tool for educators when looking for the right employer.

Operation 514—Manage Service Request: Once the Educator has published his/her schedule with the available days, Child Care Businesses will have the option to request their services through this platform. The Educator will receive an alert with the request information (e.g. email, text, web application notification) and he/she will decide whether he/she want to accept it or not based on the offer parameters.

Operation 516—Cancel/Modify Service Request: There might be cases in which the Educator needs to Cancel or Modify the service request that they ordered through the platform. Depending on how close we are to the date in which the services were booked, there might be some penalties or not.

Operation 518—Provide Feedback/Score to Child Care Business: Once the Child

Care services have been supplied and the engagement between the Child Care Business and the Educator has come to an end, both the Educators and the Child Care Businesses will have the ability to provide feedback and score the quality of the professional engagement.

Operation 520—Manage Emergency Service Request: In those cases in which the Child Care Business has launched a Child Care service request within less than 24 hours, the emergency request method will be used and the Emergency Support Desk (ESD) will support the Educators and the Child Care Business during the booking process to ensure that the request is reviewed and confirmed in a timely manner.

Operation 522—Cancel/Modify Emergency Service Request: Like the process associated to Canceling or Modifying a normal service request. In this case, the Emergency Support Desk (ESD) will have to be involved since we need any modification or cancellation to be notified to the involved parties right away.

Operation 524—Qualifications Expiration: Like the Child Care Business qualifications expiration process, this system will monitor the validity of any mandatory credentials associated to every Educator (CPR, First Aid Certification, Early Childhood Education, among others). The system will ensure that any expired credential is properly updated.

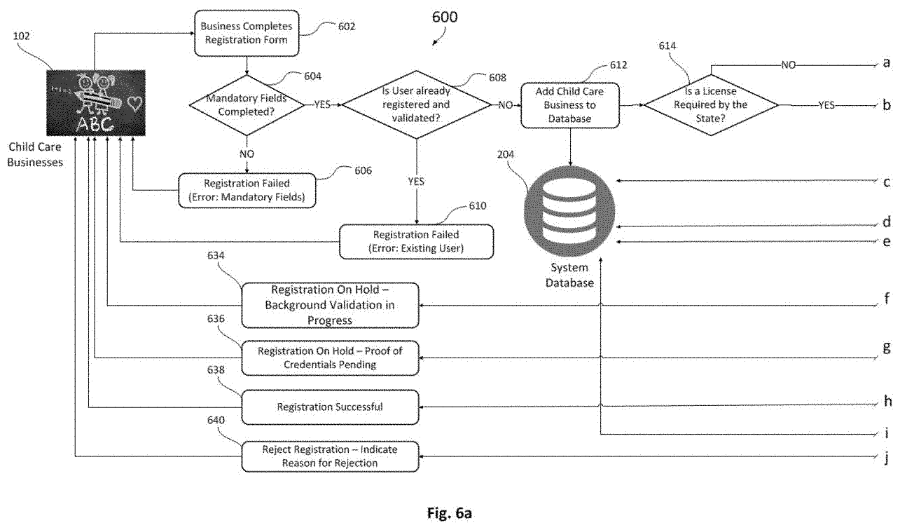

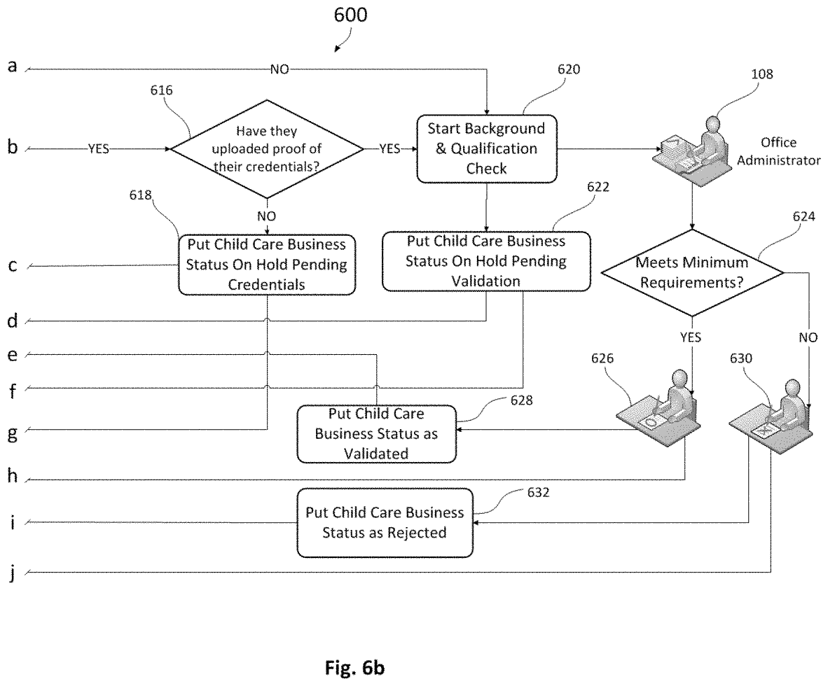

Turning to FIGS. 6a and 6b, there is illustrated a process-flow diagram 600 for registering a child care business 102 with the system 100. At block 602, the system 100 operates to present the child care business 102 with a registration form having various fields requesting information from the child care business. As an example, the requested information may include: name of the child care business; location of the child care business, which is also used for assessing licensing requirements; type of child care business (e.g., child care center, family child care home, or child care for children with special needs); License or qualification of the business (if applicable); expiration date of any licenses or certifications; information about staff that are employed at the time of registration that are at least 13 years-old that might be in contact with children (this information is used to run a background check on each staff member and anyone of age 13 or older who live in the family child care home); the business' fees; daily schedule; size and of the facility; maximum number of children they can have; current occupancy; information about meals or snack provided; educational programs offered; policies and procedures relating to safety, immunization, child behavior, pickup and drop off, emergencies, parent contact, sickness; and pictures of the facility.

It is worth noting that the fields included above are just some examples of the fields that will be required in the Child Care Business registration process. The patent claim comprises this proposed representation of the invention and any other variances in which different fields are included in the registration forms.

At block 604, before creating the account, the system will check that all mandatory fields have been completed. If there is any crucial information missing, at block 606, the Child Care Business will receive an alert message indicating that they have not provided all the necessary information and will indicate which are the missing fields that require their attention. The Child Care Business will not be able to proceed with the creation of the account until all the mandatory fields are properly completed.

At block 608, once the Child Care Business has provided all the mandatory details, the system will check that the Child Care Business is not yet included in the database. If the Child Care Business is already registered, at block 610 the system will launch an alert message indicating that this business has already an open account in the platform. If they still don't have an active account, the system will generate the account for the Child Care Business. If the Child Care Business is not registered, at block 612, the business is added to the system database 204.

Each Child Care Business account will have different status depending on what step of the registration process they are in: On Hold Pending Credentials, On Hold pending Validation, Validated, or Rejected.

At block 614, depending on the type of Child Care Business and the State where they are located, there will be different licensing and qualifications required. If licensing is required, at block 616 it is determined whether copies of the licensing has been uploaded or submitted. If the answer is no, the process proceeds to block 618, where the status the account status will be put “On Hold Pending Credentials” until the Child Care Business uploads the proof of licensing and credentials.

If the answer to the query in block 616 is yes, the process proceeds to step 620. Additionally, if the answer to the query in block 614 was no, the process proceeds directly to block 620.

As soon as the Child Care Business uploads the proof of credentials or in the event that there is not specific licensing or requirement for that specific type of Child Care Business in that State, then the system will put the account status as “On Hold pending Validation”, block 622 and send a message to the user, block 634, and the Office Administrator will commence with the background, block 620, check of the Child Care Business based on the information provided.

At block 620, the Office Administrator 108 conducts a background check and the background check may be different depending on the type of business that is being validated. For a child care center, the following are an example of information that will be checked: Proof that the center is currently licensed, the Office Administrator will check the license information uploaded by the Child Care Business and confirm that is current, acceptable in the State in which the business is operating and check for how long the business has been licensed; maximum capacity and current occupancy (how many children they currently have and the age ranges of these children); check any complaint history related to the business; review licensing inspections and compliance agreements; perform the background check of every staff member of the Child Care Business, as previously indicated, the business needs to provide a list of all the educators and any other person in their staff (director, teachers, caregivers, bus drivers, kitchen staff, janitors, cleaning people, administrative employees, and every adult volunteering that will have access to any of the children, among others); and confirm that every educator and caregiver in the center have an up-to-date Infant and Child First Aid & CPR certification.

For a family child care home, the following are an example of information that will be checked: perform a background check of anyone of age 13 or older who live in the family child care home; check the level of education of any educator in the premises; whether the home is either licensed or properly registered; and confirm that every educator and caregiver in the center have an up-to-date Infant and Child First Aid & CPR certification.

In addition to the aspects listed above, the background check of the Child Care Business (regardless of the type) will also confirm the compliance with any other mandatory requirement that is necessary on that specific State. Some examples include: completion of a minimum number of hours of Child Care Training; completion of a minimum number of hours of Early Literacy and Language Development Training; completion of a yearly in-service training to further the training and skills of the Business owner and its Educators; confirm that the caregivers in Family Child Care Homes don't perform any other unrelated job simultaneously during hours of operation; confirm the Child Care Business has emergency evacuation plans, working smoke detectors and fire extinguishers; confirm that the Child Care Business facilities provide a smoke-free environment; confirm that there are no firearms on the premises or they are properly locked and inaccessible to children as per any current applicable Federal or State laws; and confirm that no hazardous materials are accessible to children.

As previously stated, the items specified in the background check are just examples of aspects that will be reviewed by the Office Administrator in this representation of the invention. This patent claims any other background check method that reviews any other aspect different from the ones described in this section or subsequent sections.

After completing the background check, at block 624, a final assessment of the Child Care Business will be made. If the business meets the minimum requirements, then they will be accepted, block 626, and the Office Administrator will change the account status to “Validated”, block 628. Otherwise, the business will be rejected, block 630, and the account status will be changed to “Rejected”, block 632.

As soon as the assessment is done, the Child Care Business will receive a notification (message, text, email, or via any other written communication method) indicating whether the account has been validated or rejected. If the account has been rejected, details of the reason for rejection will be included in the message and clear instructions on how to resolve the problem will be added to the communication. As soon as the account is flagged as “Validated”, the Child Care Business user will have access to the rest of the account functions discuses above in connection with FIG. 3.

Parents will also need an account and be properly registered in the system before they are able to enjoy all the services described within this representation of the invention. However, Parent accounts will not require validation since no background check nor assessment will be necessary.

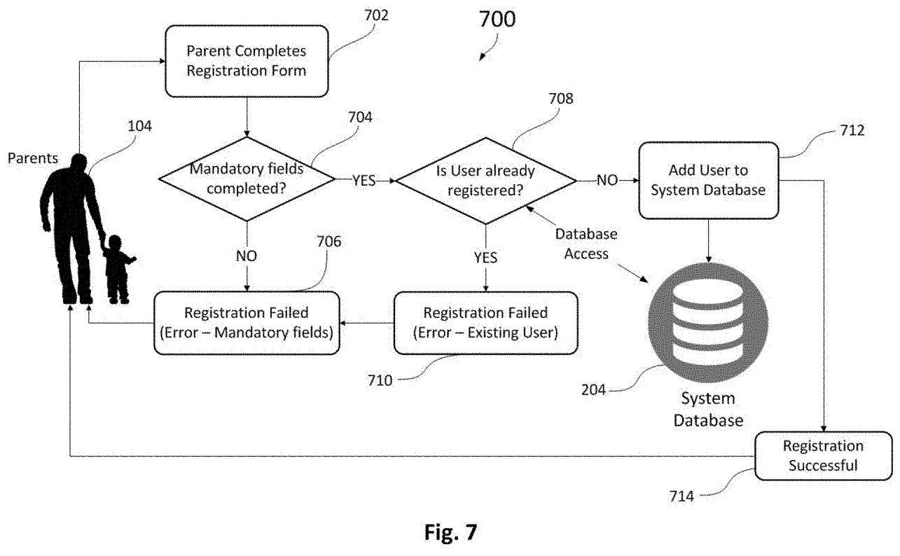

Turning to FIG. 7, there is illustrated a process-flow diagram 700 for registering a parent or guardian 104 with the system 100. At block 702, the system operates to present the parent with a registration form that includes basic information required to register the parent with the system. At block 704, it is determined whether all mandatory form fields were completed. If the answer is no, the process moves to block 706, wherein an error message is presented to the parent. If the answer is yes, the process moves to block 708, were it is determined if the parent is already registered. If the answer is yes, the process moves to block 710, wherein an error message is presented to the parent. If the answer is no, the process moves to block 712, wherein the parent registration is added to the database 204. The process then moves to block 714, wherein a successful registration message is presented to the parent.

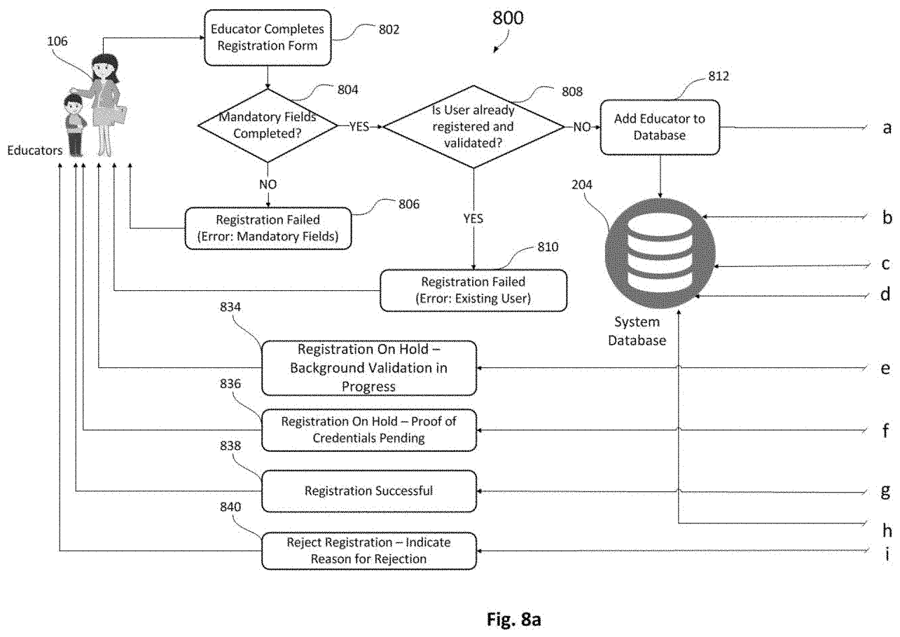

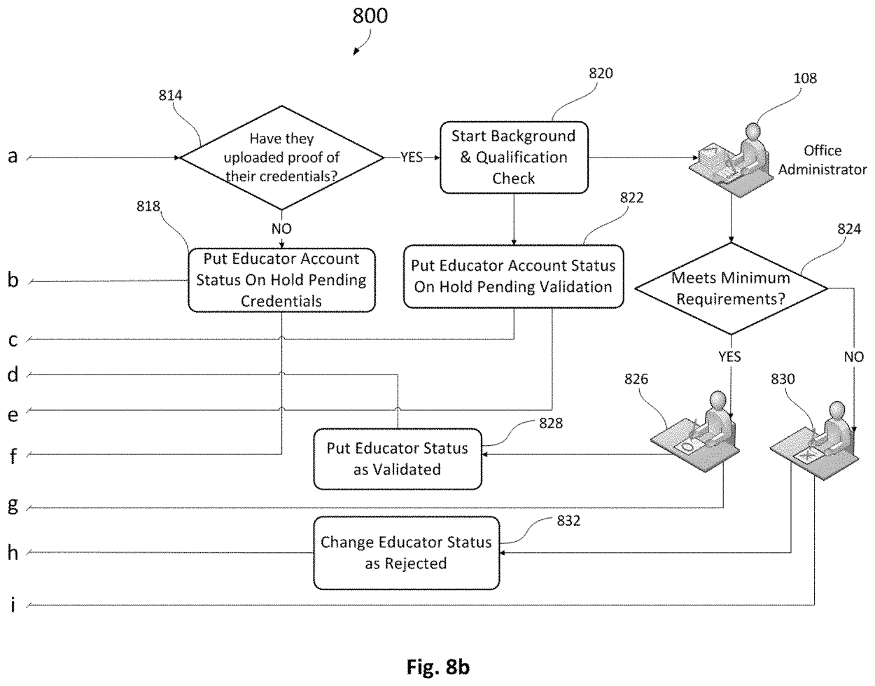

Turning to FIGS. 8a and 8b, there is illustrated a process-flow diagram 800 for registering an educator with the system. At block 802, the system operates to present the educator 106 with a registration form having various fields requesting information from the educator to register the educator with the system. As an example, the requested information may include: name and contact information of the educator; type of educator (e.g., Early Childhood Educator, Child Care Worker, Early learning for children with special needs); type of engagement (e.g., sporadic, full-time, part-time engagement); license or qualification of the educator (when applicable); whether the educator has CPR and First Aid Certification and date of last certification; and level or grade of seniority and expertise the educator presently has.

It is worth noting that the fields included above are just some examples of the fields that will be required in the Educator registration process. The patent claim comprises this proposed representation of the invention and any other variances in which different fields are included in the registration forms.

At block 804, it is determined whether all mandatory form fields were completed. If the answer is no, the process moves to block 806, wherein an error message is presented to the educator. If the answer is yes, the process moves to block 808, were it is determined if the educator is already registered. If the answer is yes, the process moves to block 810, wherein an error message is presented to the educator. If the answer is no, the process moves to block 812, wherein the educator registration is added to the database 204.

Educators accounts will have different status depending on what step of the registration process they are in: On Hold Pending Credentials, On Hold Pending Validation, Validated, and Rejected.

The first time an educator opens an account its default status will be “On Hold Pending Credentials”. This status will lock the Educator account until they upload the educator's credentials. Once the credentials are uploaded, then the system will put the account status as “On Hold pending Validation” and the Office Administrator will commence with the background check of the Educator.

At block 814, it is determined whether copies of the licensing have been uploaded or submitted. If the answer is no, the process proceeds to block 818, where the status the account status will be put “On Hold Pending Credentials” until the educator uploads the proof of licensing and credentials. If the answer to the query in block 814 is yes, the process proceeds to step 820.

As soon as the educator uploads the proof of credentials the system will put the account status as “On Hold pending Validation”, block 822, and the Office Administrator 108 will commence with the background, block 820, check of the educator based on the information provided. The following are an example of information that will be checked: confirm the educator has an up-to-date Infant and Child First Aid & CPR certification; confirm the educator does not have any criminal record or child abuse claim; confirm the educator has a valid work Visa or Green Card in case the educator is not a citizen of the United States; confirm the educator has the minimum level of education or minimum number of years of experience required; and check references.

After completing the background check, at block 824, a final assessment of the educator is made. If the educator meets the minimum requirements, then the educator will be accepted, block 826, and the Office Administrator will change the account status to “Validated”, block 828. Otherwise, the educator will be rejected, block 830, and the account status will be changed to “Rejected”, block 832.

As soon as the assessment is performed, the Educator will receive a notification (message, text, email, or via any other written communication method) indicating whether the account has been validated or rejected. If the account has been rejected, details of the reason for rejection will be provided as well as instructions on how to amend the identified issues.

On the other hand, as soon as the account is flagged as “Validated”, the Educator will have access to the rest of operations that were described above in connection with FIG. 5 and will become members of the Employee Pool on Demand, the ePOND.

Every user will have the ability to update and modify the data in its profile at any time. The profile fields will be different for Parents, Child Care Businesses, and Educators. When any user updates its profile, the system will check that all mandatory fields are properly filled out before allowing any changes. If a mandatory field has not been provided, the system will provide an error message indicating the field or fields that are missing. Once all mandatory fields are provided, the system will connect to the Database and will replace/update the existing information.

Since no background check is necessary for Parent users, the method to update their profile will be very simple. However, for Child Care Businesses and Educators, there might be cases in which a new validation of the credentials will be necessary and therefore the profile update workflow will be much more complex.

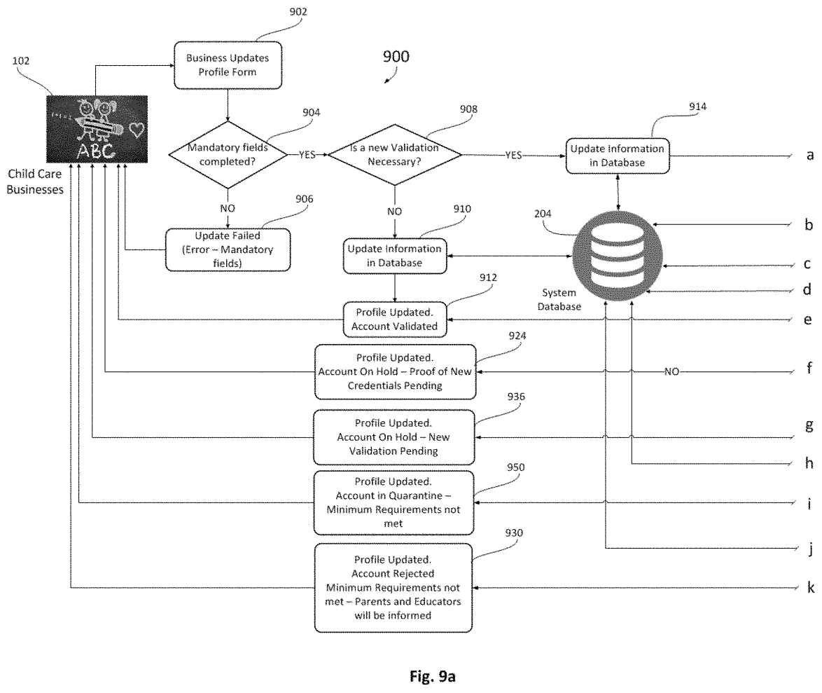

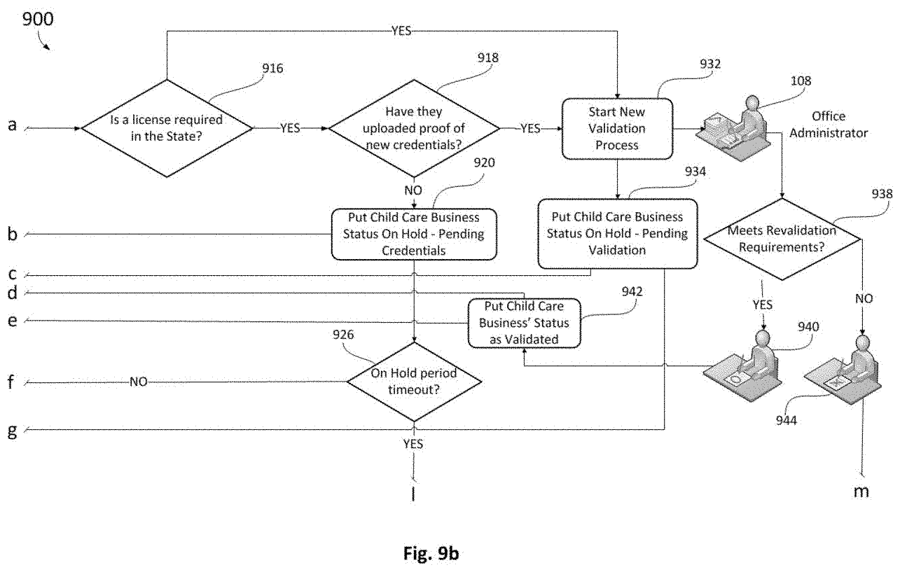

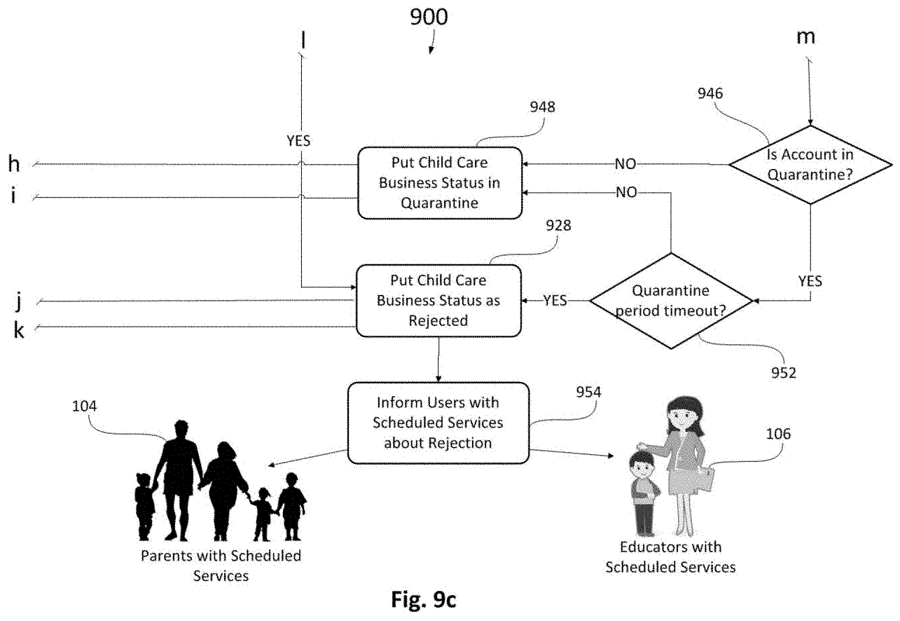

In FIGS. 9a-9b there is illustrated a process-flow diagram 900 for updating a Child Care Business profile. At block 902, the system operates to present the business 102 with a profile update form having various fields requesting information from the educator. In embodiments, this information can be the same information that was requested to register the business with the system.

At block 904, it is determined whether all mandatory form fields were completed. If the answer is no, the process moves to block 906, wherein an error message is presented to the user. If the answer is yes, the process moves to block 908, were it is determined whether new validation is required for the user.

The modification of some fields in the Child Care Business profile might trigger a new validation process. For example, if a Family Child Care Home changes its location (the family moves to a different State), the rules and regulations might be different in that specific State and therefore a new validation will be required. Similarly, if a Child Care Business recruits a new Educator that is not registered in the system, a background check will also be necessary. These are just a couple of examples of profile modifications that might trigger a new validation. All the fields that will trigger this validation process are specified in the previous list.

If at block 908 it is determined that no new validation is required, the process moves to block 910, wherein the profile information is updated in the database 204, and the account status is set to profile updated, account validated, block 912. However, if at block 908 it is determined that new validation is required, the process moves to block 914, wherein the profile information is updated in the database, and then the process moves to block 916.

At block 916, depending on the type of Child Care Business and the State where they are located, there will be different licensing and qualifications required. If licensing is required, at block 918 it is determined whether copies of the licensing has been uploaded or submitted. If the answer is no, the process proceeds to block 920, where the status the account status will be put “On Hold Pending Credentials” until the Child Care Business uploads the proof of licensing and credentials and a message will be sent to the user, block 924.

If the Child Care Business has changed its credentials or the previous ones are no longer valid, they will have to upload the latest version of valid credentials. The account will be put “On Hold Pending credentials” until those are uploaded. The system will define a period in which an existing account will be allowed to be On Hold Pending the new credentials. If the Child Care Business doesn't provide the updated credentials within that period, block 926, the account will be Rejected, block 928, and a message will be sent to the user, block 930.

If the answer to the query in block 918 is yes, the process proceeds to step 932. Additionally, if the answer to the query in block 916 was no, the process proceeds directly to block 932.

As soon as the Child Care Business uploads the proof of credentials or if there is not specific licensing or requirement for that specific type of Child Care Business in that State, then the system will put the account status as “On Hold pending Validation”, block 934, and a message will be sent to the user, block 936. The Office Administrator will commence with the revalidation, block 932, based on the information provided in the profile update. Validation process will start if any of the fields that have been modified require to be properly vetted. The account will be put On Hold while this validation takes place, but the Child Care Business will still be able to perform any tasks normally. The revalidation process should be completely transparent to the User if they comply with the minimum requirements.

At block 938, it is determined if the business is to be revalidated. If the answer is yes, the process moves to block 940 wherein the business is reaccepted, the account status is set to validated, block 942, and a message is sent to the user, block 912. If the answer is no, the process moves to block 944, wherein the business is rejected, and the process moves to block 946.

If the Child Care Business doesn't meet the minimum requirements after performing the new validation process, the account will be put in Quarantine. This status will allow the Child Care Business to amend the aspects that are not compliant with the minimum requirements without impacting any on-going Child Care Services within the platform. The Child Care business will have a specific period to provide the necessary information so that the business is properly approved. If the Child Care business doesn't amend this situation within the maximum period allowed, then the account will be Rejected.

At block 946 it is determined with the account status is set to Quarantine. If the answer is no, the process moves to step 948, wherein the status is set to Quarantine, and a message is sent to the user, block 950. If the answer is yes, the process moves to block 952, wherein it is determined whether the quarantine period has expired. If the answer is no, the process moves to block 948. If the answer is yes, the process moves to block 928, wherein the user or account status is set to Rejected, and a message, block 954, is sent to users 104 and 102.

When an existing Child Care Business account previously validated is updated to a “Rejected” status, the business account will lose its privileges and they won't be able to offer any more Child Care Services through the platform until it is properly revalidated, and it meets the minimum requirements again. If the Child Care Business has Scheduled Services with Parents or Educators in the system, those will be properly informed about the new status of the account. It will be the Parents' and Educators' decision to either continue or cancel the Scheduled Services with this Child Care Business. If they decide to continue engaging with an unqualified business, it will be their sole responsibility. Any method in the platform other than the profile management or log-in/log-out will be disabled for the unqualified business (for example, the scoring system, updating their availability schedule, offering any new Child Care Services or engaging with Educators, among others).

As previously stated, Parents can optionally indicate their preferences in relation to Child Care Services and desired characteristics in a Child Care Business. Those details will help the system identify the group of Child Care Businesses that best fit the Parents needs. Examples of the preference details include: the type of Child Care business that the parents are interested in (e.g., Child Care Centre, Family Child Care Home or Child Care for Children with Special Needs); whether the parents are looking for licensed businesses or just registered ones; looking for monthly permanent services or just sporadic Child Care services; the location in which the Child Care Services will be required; the range of monthly or drop-in fees that is acceptable for the family; the type of meals that are preferred; preferred immunization policies; the type of educational programs that are preferred; the type of Child Behavioral Discipline that is acceptable (e.g., redirection, reinforcement of positive behavior, among others); and other preferences.

Additionally, the system presents the parent user with a Parent Information Form that includes all relevant information that a Child Care Business requires to take proper care of a child. This information is paramount to ensure a satisfactory engagement between Child Care Businesses and Parents and therefore it will be required before a Parent User is able to book Child Care Services through the platform.

In this form Parents will provide critical details such as family/contact information, emergency contact information, immunization status, allergies, child medical insurance coverage, consent to medical care and treatment if something happens, consent to video and pictures, consent to outdoor activities and walks, among others.

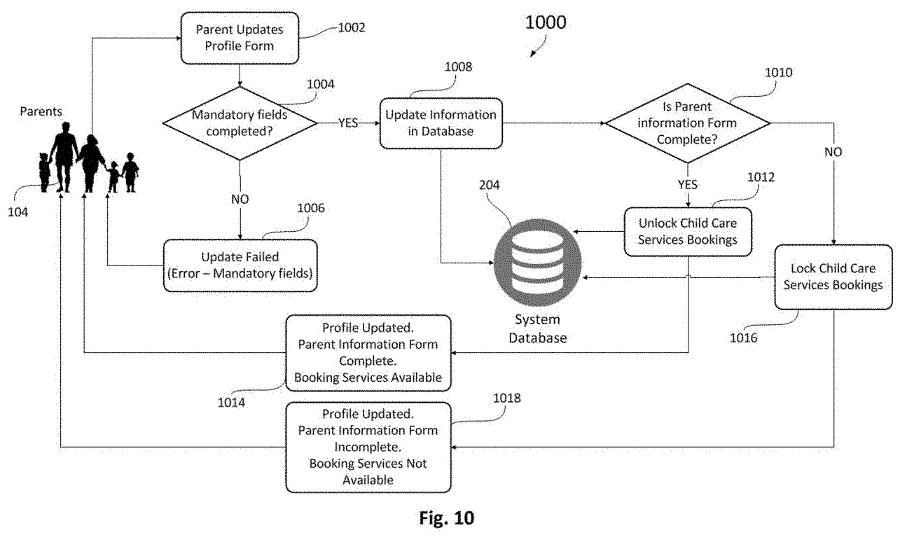

With reference to FIG. 10, there is illustrated a process-flow diagram 1000 for updating a parent profile, including ensuring that the parent information form is completed. At block 1002 a form including all the required information is presented to the user for completing by the user. Upon submission of the form, the process proceeds to block 1004 where it is determined if all mandatory fields are completed. If the answer is no, the process proceeds to block 1006 wherein an error message is presented to the user that indicated missing mandatory fields. If the answer is yes, then the process proceeds to block 1008, wherein the information is updated in the database 204, and then proceeds to block 1010.

At block 1010, the process determines if the Parent Form has been completed. If the answer is yes, the process proceeds to block 1012, wherein the parent can book services and the account status is changed to Profile Updated; Parent Form Completed; Booking Services Available and a message is sent to the user of the status update. If the answer is no at block 1010, the process proceeds to block 1016, wherein the booking service is locked, and the account status is changed to Profile Updated; Parent Form Incomplete; Booking Service unavailable, and a message is sent to the user.

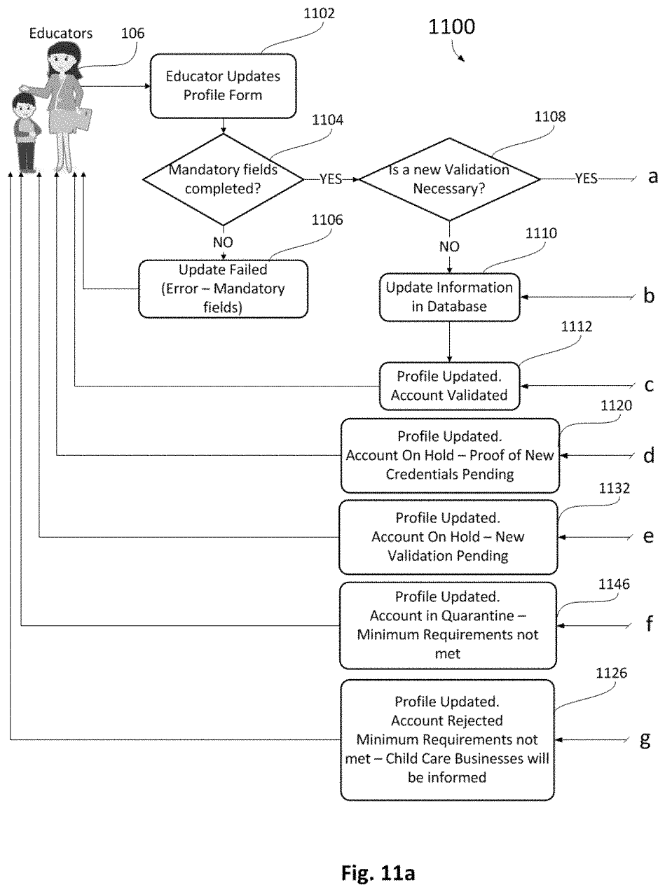

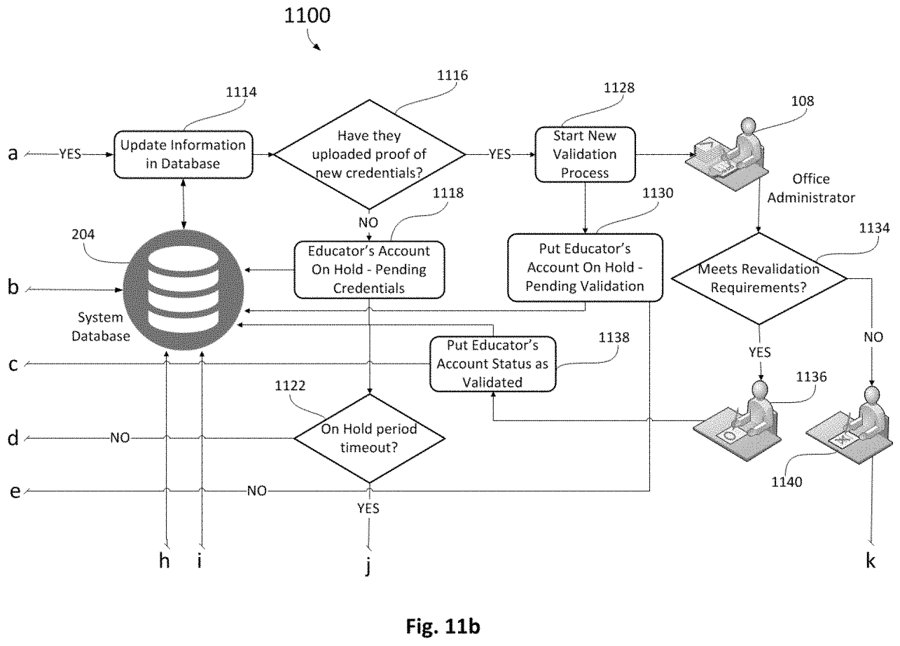

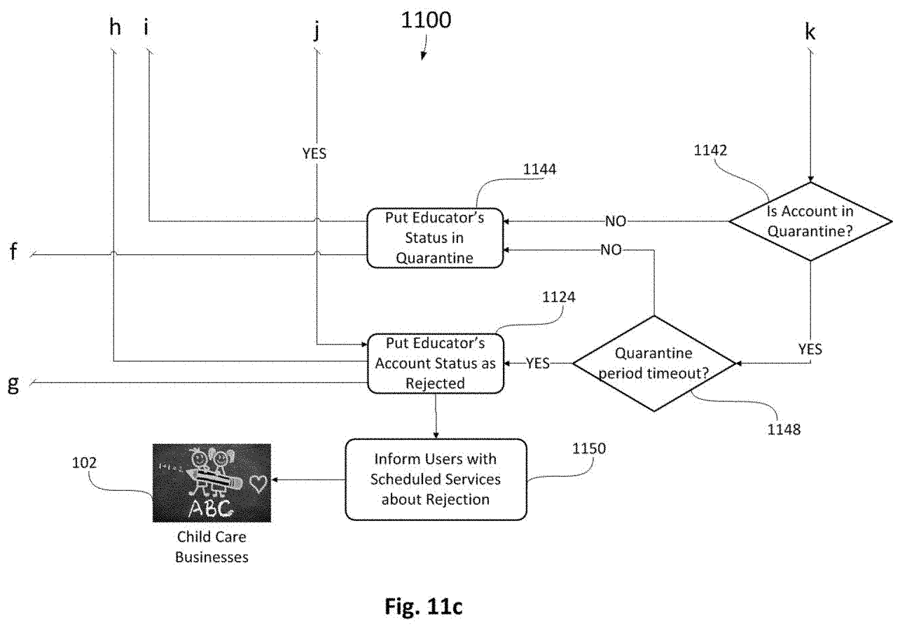

Turning now to FIGS. 11a-11c, there is illustrated a process-flow diagram 1100 for updating an Educator profile. At block 1102, the system operates to present the Educator 106 with a profile update form having various fields requesting information from the Educator. In embodiments, this information can be the same information that was requested to register the Educator with the system, and it can also include various preferences. Upon submission of the form, the process moves to block 1104.

At block 1104, it is determined whether all mandatory form fields were completed. If the answer is no, the process moves to block 1106, wherein an error message is presented to the user. If the answer is yes, the process moves to block 1108, were it is determined whether new validation is required for the user.

The modification of some fields in the Educator profile might trigger a new validation process. If at block 1108 it is determined that no new validation is required, the process moves to block 1110, wherein the profile information is updated in the database 204, and the account status is set to profile updated, account validated, block 1112, and a message is sent to the user. However, if at block 1108 it is determined that new validation is required, the process moves to block 1114, wherein the profile information is updated in the database, and then the process moves to block 1116.

At block 1116, it is determined whether copies of the licensing have been uploaded or submitted. If the answer is no, the process proceeds to block 1118, where the status the account status will be put “On Hold Pending Credentials” until the Educator uploads the proof of licensing and credentials and a message will be sent to the user, block 1120.

If the Educator has changed its credentials or the previous ones are no longer valid, they will have to upload the latest version of valid credentials. The account will be put “On Hold Pending credentials” until those are uploaded. The system will define a period in which an existing account will be allowed to be On Hold Pending the new credentials. If the Educator doesn't provide the updated credentials within that period, block 1122, the account will be Rejected, block 1124, and a message will be sent to the user, block 1126.

When an existing Educator account previously validated is updated to a “Rejected” status, the Educator will lose his/her privileges and won't be able to offer their services and/or commit to support any more Child Care Businesses through the platform until the account meets the minimum requirements again. If the Educator has Scheduled Services with Child Care Businesses through the system, they will be properly informed about the new status of the Educator's account. It will be the Child Care Business' decision to either continue or cancel the Scheduled Services with this Educator. However, if they decide to continue working with this unqualified educator, the Child Care Business will be negatively impacted as they will have to be revalidated and they might no longer comply with the minimum requirements.

If the answer to the query in block 1116 is yes, the process proceeds to step 1128 the system will put the account status as “On Hold pending Validation”, block 1130, and a message will be sent to the user, block 1132. The Office Administrator will commence with the revalidation based on the information provided in the profile update. Validation process will start if any of the fields that have been modified require to be properly vetted. The account will be put On Hold while this validation takes place, but the Educator will still be able to perform any tasks normally. The revalidation process should be completely transparent to the user if they comply with the minimum requirements.

At block 1134, it is determined if the business is to be revalidated. If the answer is yes, the process moves to block 1136 wherein the business is reaccepted, the account status is set to validated, block 1138, and a message is sent to the user, block 1112. If the answer is no, the process moves to block 1140, wherein the business is rejected, and the process moves to block 1142.

If the Educator doesn't meet the minimum requirements after performing the new validation process, the account will be put in Quarantine. This status will allow the Educator to amend the aspects that are not compliant with the minimum requirements without impacting any on-going services within the platform. The Educator will have a specific period to provide the necessary information so that the Educator is properly approved. If the Educator doesn't amend this situation within the maximum period allowed, then the account will be Rejected.

At block 1142 it is determined with the account status is set to Quarantine. If the answer is no, the process moves to step 1144, wherein the status is set to Quarantine, and a message is sent to the user, block 1146. If the answer is yes, the process moves to block 1148, wherein it is determined whether the quarantine period has expired. If the answer is no, the process moves to block 1144. If the answer is yes, the process moves to block 1124, wherein the user or account status is set to Rejected, and a message, block 1150, is sent to users 102.

The expiration date of the Child Care Business license, CPR and First Aid Certification and any other mandatory qualification necessary in each State will also trigger an “automatic validation process” by the time the qualification is expired.

The system will periodically check in the background the expiration date of these qualifications. A month before the qualification is expired, the system will send a message to the user indicating that one of his/her qualifications is about to expire. During that period, the Child Care Business or the Educator with those almost-expired qualifications will have the ability to log into their profile, update their new credentials and trigger a new validation process as shown as discussed above.

By the expiration date, if the user (Child Care Business or Educator) has not updated their credentials, the system will flag their account as “Credentials expired” and the account will be put On Hold. The system will allow the user to be On Hold for a limited period. Once the maximum On-Hold allowed time is reached, the system will put the account as “Rejected” and any Parent or Educator involved with the Rejected user account will be properly informed.

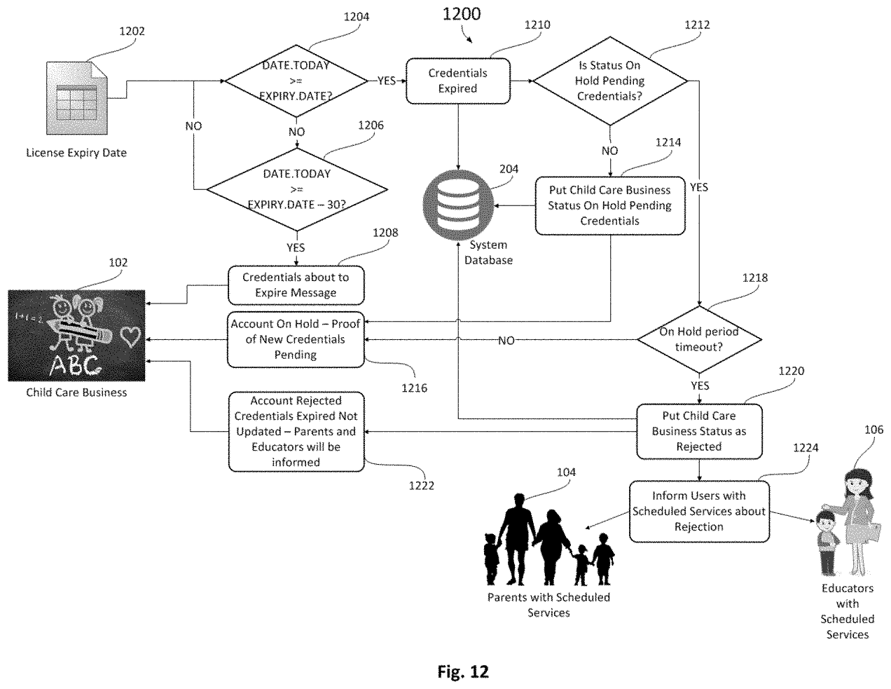

With reference to FIG. 12, there is illustrated a process-flow diagram 1200 for monitoring the expiration of a Child Care Business licensing. The expiration date of one or more licenses 1202 is accessed from database 204. At block 1204, it is determined whether the current date is greater than or equal to the expiration date. If the answer is no, the process moves to block 1206. At block 1206 it is determined whether the current date is greater than or equal to the expiration date minus 30 days. If the answer is no, the process loops to block 1204. If the answer is yes, the message is sent to the user about the pending expiration date, block 1208, and the process loops to block 1204.

If at block 1204 it is determined the current date is greater than or equal to the expiration date, the process moves to block 1210, wherein the account status is updated with Credentials Expired. Then at block 1212, it is determined whether the account is on hold pending uploading or providing new credentials. If the answer is no, the process moves to block 1214, wherein the account status is updated to hold pending credentials, and a message is sent to the user, block 1216 then the process loops to block 1212.

If at block 1212 the answer is yes, the process moves to block 1218 where it is determined whether the hold period has expired for the user to upload the new credentials. If the answer is no, the process loops. If the answer is yes, the process moves to block 1220, wherein the account status is set to Rejected, a message is sent to the user, block 1222, and a message is sent to parents 104 and educators 106 with scheduled services, block 1224.

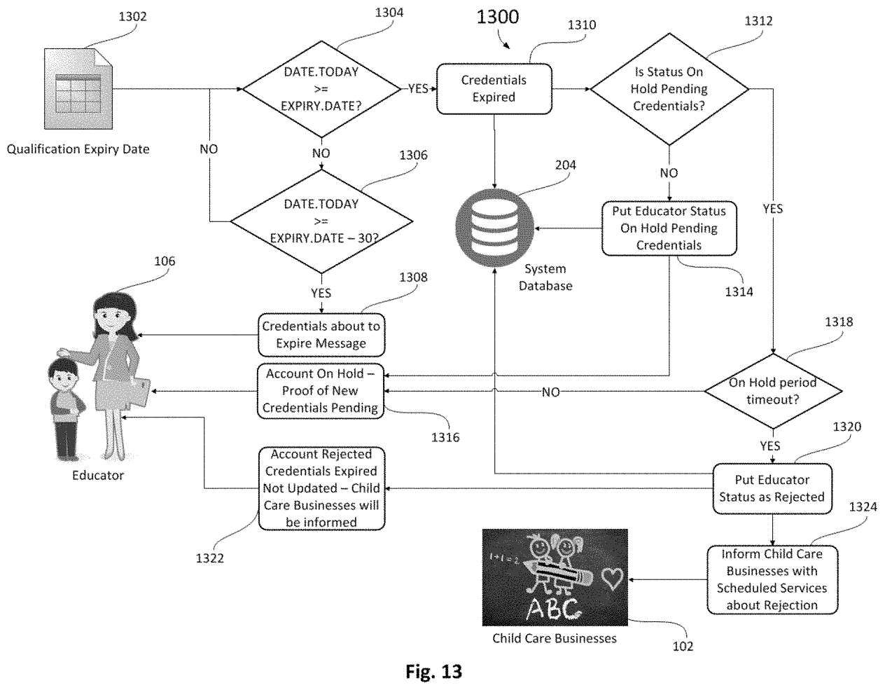

With reference to FIG. 13, there is illustrated a process-flow diagram 1300 for monitoring the expiration of an Educator qualification. The expiration date of one or more qualifications 1302 is accessed from database 204. At block 1304, it is determined whether the current date is greater than or equal to the expiration date. If the answer is no, the process moves to block 1306. At block 1306 it is determined whether the current date is greater than or equal to the expiration date minus 30 days. If the answer is no, the process loops to block 1304. If the answer is yes, the message is sent to the user about the pending expiration date, block 1308, and the process loops to block 1304.

If at block 1304 it is determined the current date is greater than or equal to the expiration date, the process moves to block 1310, wherein the account status is updated with Credentials Expired. Then at block 1312, it is determined whether the account is on hold pending uploading or providing new credentials. If the answer is no, the process moves to block 1314, wherein the account status is updated to hold pending credentials, and a message is sent to the user, block 1316 then the process loops to block 1312.

If at block 1312 the answer is yes, the process moves to block 1318 where it is determined whether the hold period has expired for the user to upload the new credentials. If the answer is no, the process loops. If the answer is yes, the process moves to block 1320, wherein the account status is set to Rejected, a message is sent to the user, block 1322, and a message is sent to Child Care Business 102 with scheduled services, block 1324.

As previously described, both the Child Care business and Educator accounts will be able to update and show their availability and offer their services. Specific details of this method depending on the type of User are described next

To ensure that Child Care Businesses maximize the utilization of their resources and the children occupancy of their facilities, the Child Care Businesses will be able to offer any unused spots through the Availability Schedule in the platform.

Child Care Businesses will be able to update a calendar indicating any available spots and the age range associated to each of those spots per day. This calendar will have to be periodically updated to ensure that the information provided in the platform is the latest and greatest. The calendar update will be done either manually (by the Child Care Business Director or Representative) or automatically every time that the Child Care Business offers any of these spots through the platform.

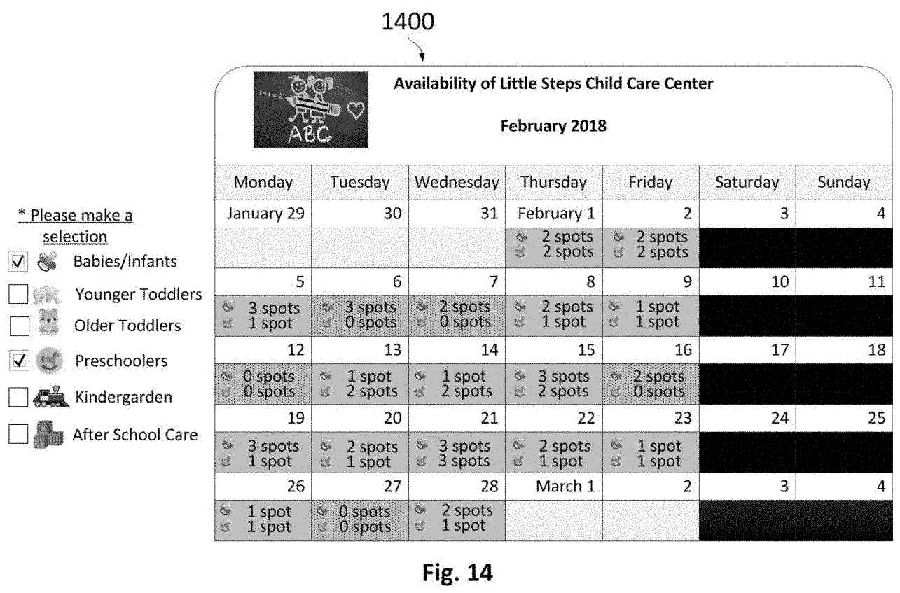

By selecting a specific age range, the System will show a color-coded calendar indicating the number of spots available for that selection. In this representation of the invention, when the day is red it means that there are not available spots for the age range selection. Similarly, when the day is green it means that there are available spots for the age range specified in the selection. A legend with the meaning of the colors will be included in the User interface. In addition, the type of calendar view (monthly, weekly or daily) will be also one of the parameters available for the user. An example of the look and feel of the Availability Schedule 1400 for a Child Care Business is shown in FIG. 14.

Like the Child Care Business, Educators will be also able to specify in their schedule their availability per day so that they can be engaged by Child Care Business when necessary. Like in the previous case, this calendar will have to be periodically updated either manually by the Educator or automatically by the system in order to ensure that the information existing in the platform is always up to date.

The Educator's schedule will be automatically updated every time a Child Care Business books any of the Educator's open spots through the platform. The Educator can always manually update their own schedule in case that any other personal or professional commitment arises outside the invention.

One crucial characteristic of this representation of the invention is that the Educator's availability will be determined by not only the date but also the location. In nowadays society, people are more mobile and flexible than ever before and therefore, this invention needs to take this into consideration and use that mobility as an additional powerful asset. As a result, when the Educator specifies their availability in the calendar, they can indicate their profile location as a default or they can modify the location for specific dates as they consider.

However, since the Educators are only validated for specific States depending on their credentials and qualifications, the system will limit the Educator's selection of the location to those States or geographic areas where the Educator has been validated and is qualified to work in.

When reviewing an Educator's availability, the Child Care Businesses will specify not only their dates of interest but also the location where the services will be provided. The System will show a color-coded calendar indicating the days in which the Educator is available at a specific location. Likewise, when the day in the calendar is highlighted in red, it means that the Educator is not available that date at that location. When the day is highlighted in green, it means that the Educator is available, and Child Care Business can engage with them. The Educators' user interface will also have a legend with the meaning of the colors in the calendar and will have a parameter to specify the type of calendar view: Monthly, weekly or daily.

If a Child Care Business has facilities in separate locations, they can modify the location where the support will be needed, and the availability calendar of the Educator will be dynamically modified showing the updated availability based on the new criteria.

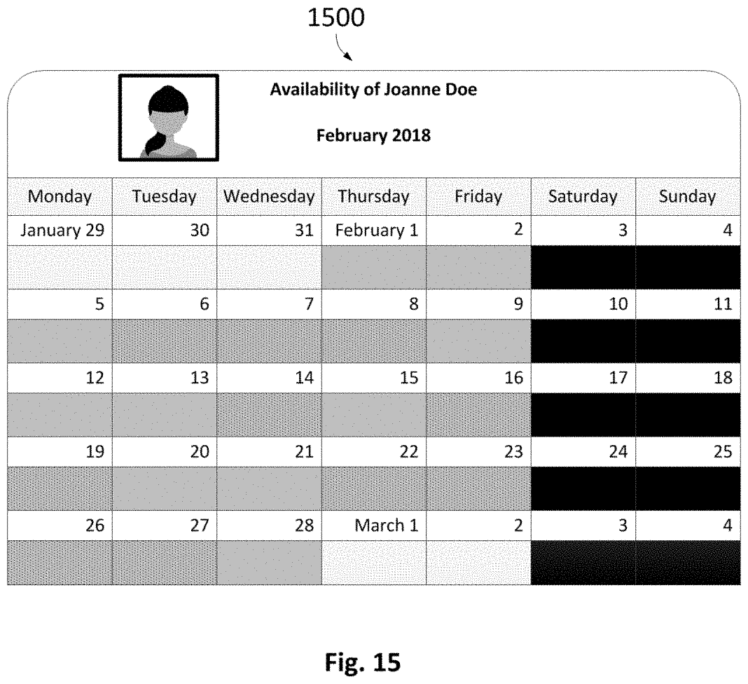

In other incarnation of the invention, partial days availability might be considered: Blue for only mornings, Yellow for only afternoons, green for full day availability and red for no availability at all, for example. However, for simplification purposes, in this representation of the invention we will just consider that the Educator's availability will be managed daily. An example of how the Educator's calendar 1500 would look like is shown in FIG. 15.

Identifying the right Child Care Business that will take care of a child is not an easy task for a Parent. Similarly, finding the right Educator that will fit with a specific Child Care Business is also a very complex task. One of the biggest advantages of embodiments of the invention is the availability to search for Child Care Businesses or Educators that are aligned with the characteristics that each user is looking for.

There are several aspects to be taken in consideration when looking for the right Child Care Business to enroll a child. Nowadays, the information related to Child Care Businesses in a specific area is limited, difficult to find and distributed throughout different platforms: newspaper ads, online search engines, community panel boards, other parents' recommendations, etc. Therefore, making a selection that meets the Parent needs and preferences is not a simple task and, in most of the cases, requires an excessive number of hours to be invested without a guaranteed successful outcome. Likewise, focusing on Educators, finding the right business to work for that meets the individual principles, Early Childhood education vision and is a good employer, is a process that might take months, if not years.

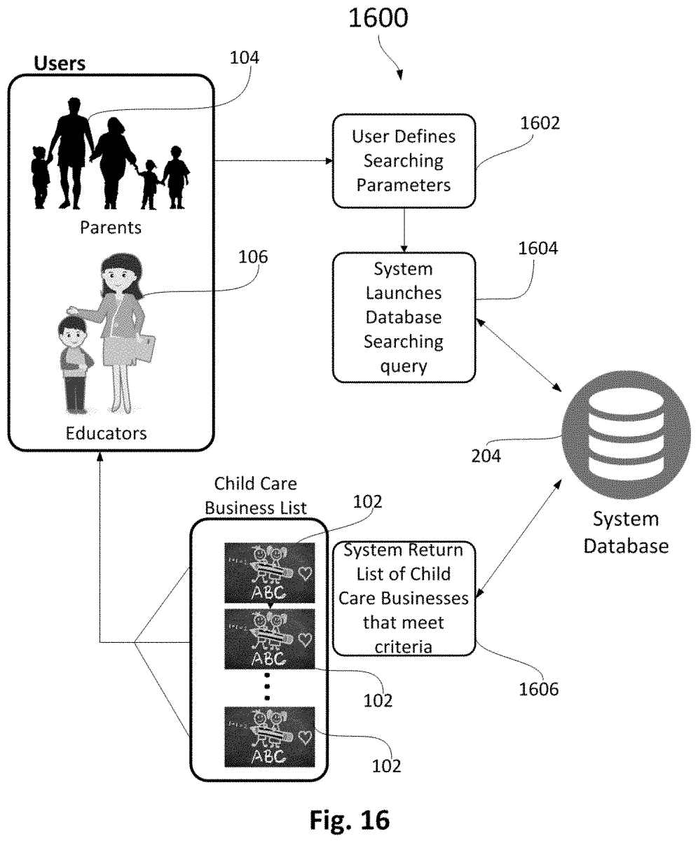

In FIG. 16 there is shown a representation of a filtering method workflow 1600 when Parents and Educators are searching for Child Care Businesses that meet specific criteria. At block 1602 a search form is presented to the user and the user can select or enter specific search criteria relating to the user's needs. Any field/information related to a Child Care Business will be a possible searching parameter for this method. Please also note that Parents or Educators won't have to specify all the searching parameters to launch a query. Those fields that are left empty or with no selection, will not be used when filtering the system database 204.

Upon submitting the search request, at block 1604 the database 204 is queried and results are then returned and displayed to the user at block 1606. The results include a listing of Child Care Businesses 102 that meet the search criteria. From there, Parents or Educators will have the chance to access the Profile of each of those Child Care Business, obtain more details and review the pictures of the facilities (when available). In addition, Parents will have the ability to separately check each Child Care business availability schedule as shown in FIG. 14 and determine whether the business will have the required spots available at a specific date. Information such as when a Child Care Business will have an open house to get a tour of their facilities or the process to book an appointment with the Child Care Business Director will be included in the Child Care Business profile information.

All these tasks will be performed just with a couple of mouse clicks or by easily using the smartphone user interface of the platform. In a matter of minutes, the Parents and Educators will have access to a whole Child care business database and will be able to search for, filter and select a Child Care Business without much effort.

Fortunately, the Database of this invention will gather all the necessary information related to Child Care Businesses in a specific geographic area and the Parent and/or Educator Users will be able to explore the profile of each of those businesses and filter them based on their requirements and searching parameters.

In embodiments, Child Care Businesses will have the ability to search for Educators. As previously discussed, as soon as Educators are validated within the system, they are included in what is called the “ePOND: “Employee Pool On Demand”. The ePOND comprises the whole group of qualified educators that will support the Child Care Businesses staffing needs, either long-term (recruiting the educator and adding him/her to their payroll) or short-term (covering any shortage of staff during just a few days or hours).

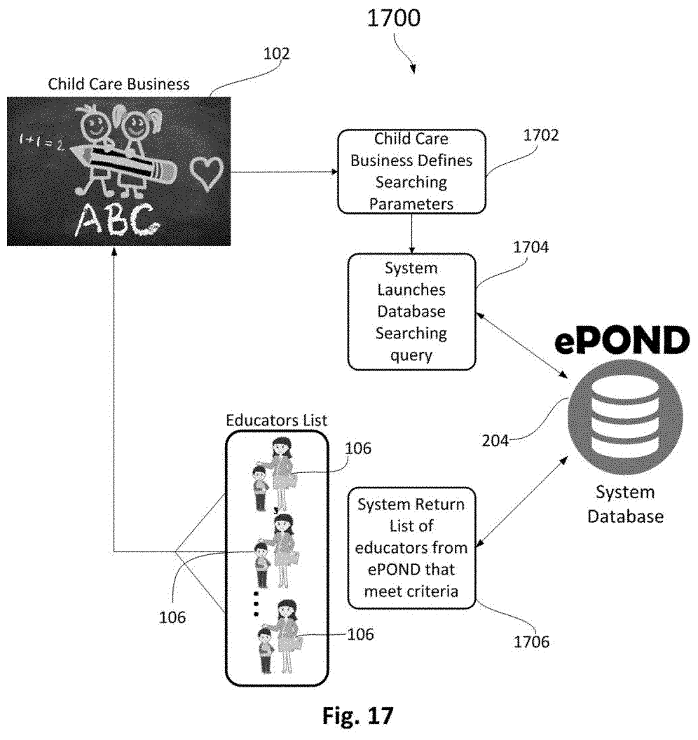

In FIG. 17 there is shown a representation of a filtering method workflow 1700 when a Child Care Business is search for Educators that meet specific criteria, the Child Care Business will indicate a group of parameters required for the educator, block 1702, and the system will do an automatic search, block 1704, within the ePOND in the database 204. The invention will return, block 1706, the list of educators 106 that meet the criteria so that the Child Care Business has the ability to review their profile and schedule availability and determine which one is the right candidate to engage with.

It is important to highlight that one of the parameters that can be specified when accessing the ePOND is the Educator's availability and the location where the services will be required. By doing this, the system will return those candidates that not only meet the personal and professional requirements but are also available in a specific location/area during the requested dates.

As previously indicated in this document, the Educators can be engaged for a sporadic short-term support or for long-term support (added to Child Care Business payroll). If an Educator is not interested in short-term engagements as per their profile, the system will not include them in the list of available educators when a Child Care Business is looking for a quick one-day substitution for example. Thanks to this approach, the engagement between Child Care Businesses and Educators will be more efficient and, in the end, more satisfactory to the parties involved.

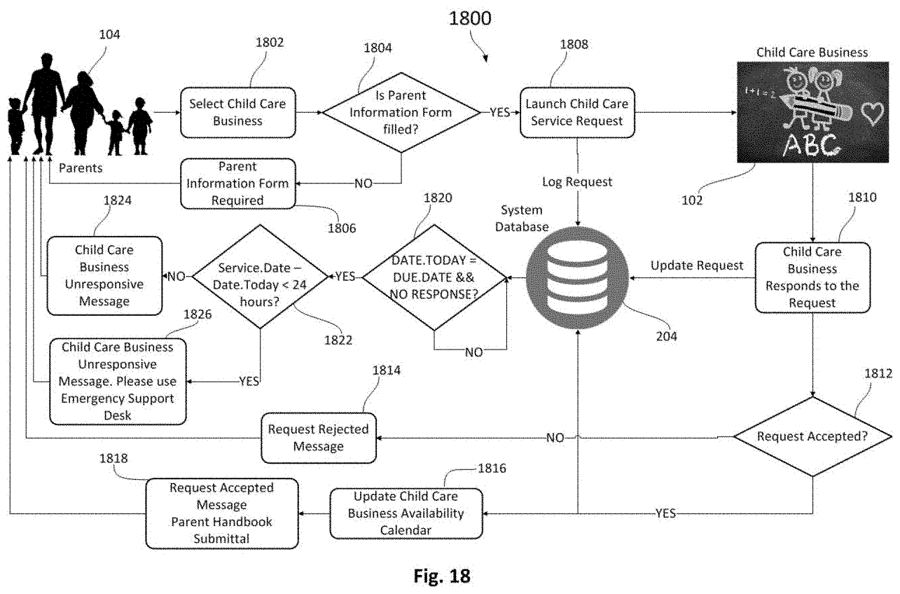

Turning now to FIG. 18, there is illustrated a process-flow diagram 1800 a parent request of child care services. At block 1802, the parent selects a desired Child Care Business, and the process moves to block 1804. At block 1804, it is determined whether the parent user has completed the Parent Information Form. If the answer is no, the process moves to block 1806, wherein a message is sent to the user 104. If the answer is yes, the process moves to block 1808 wherein the child care service request is launched. Parents will be able to launch the Service Request indicating the following parameters: number of children to be taken to the Child Care Business; age of the children to be taken to the Child Care Business; dates when the Child Care Services will be required; response due date (the Child Care Business will have to respond by rejecting or accepting the request by the response due date; and any other additional notes. And the request is sent to the selected Child Care Business 102.

After the request is sent, the process determines if the child care business 102 responds before the due date submitted by the parent 104. At block 1820, it is determined whether the current date is equal to the due date set by the parent 104 in the service request and whether the child care business 102 has already provided a response to the parent. The process loops at block 1820 until the child care business 102 provides a response or until the due date is reached, whichever happens first. As soon as the child care business 102 provides the response, the system finalizes the loop process that monitors that the parent 104 receives a response before the due date. If the child care business 102 does not respond before the due date, the process moves to block 1822.

At block 1822, it is determined if the number of hours in the service date minus current day is less than 24 hours. If the answer is no, the process moves to block 1824, wherein a message is sent to the user indicating the Child Care Business is unresponsive. If the answer is yes, the process moves to block 1826, wherein a message is sent to the user indicated that the Child Care Business is unresponsive and to contact the Emergency Help Desk.

Returning to block 1810, if the Child Care Business responds to the service request, it is determined in block 1812 whether the request is accepted. If the request is not accepted the process moves to block 1814, wherein a message is sent to the user indicating the same. If the request is accepted, the process moves to block 1816, wherein the Child Care Business Availability Calendar is updated to reflect the now unavailable spots, and a message is sent to the user, block 1818. The system will also send the Child Care Business “Parent Handbook” for the parents to review and acknowledge. This review and acknowledgement can be done online through the system or they can review and acknowledge by the time that they leave the child in the Child Care Business premises.

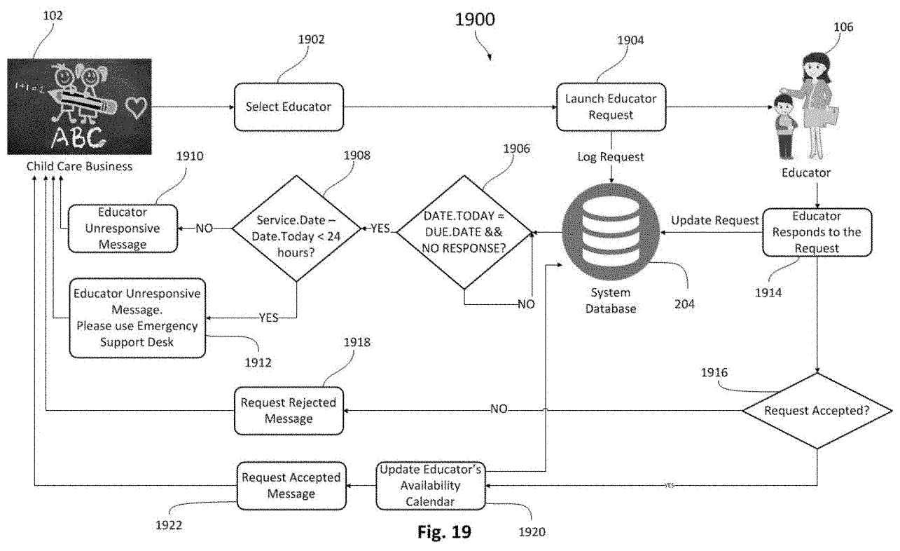

Turning now to FIG. 19, there is illustrated a process-flow diagram 1900 a Child Care Business request of Educator services. At block 1902, the Child Care Business selects a desired Educator, and the process moves to block 1904. At block 1904, the Educator service request is launched. Child Care Businesses will check the availability of the educators through their Calendars and launch a Service Request indicating the following parameters: type of engagement (e.g., sporadic engagement, part-time or full-time); location of the engagement; duration of the engagement; remuneration for the services; Response Due Date (the Educator will have to respond by rejecting or accepting the request by the response due date; and any additional comments. And the request is sent to the selected Educator 106.

After the request is sent, the process determines if the educator 106 responds before the due date submitted by the child care business 102. At block 1906 it is determined whether the current date is equal to the due date set by the child care business 102 in the service request and whether the Educator 106 has responded. The process loops at block 1906 until the educator 106 provides a response or until the due date is reached, whichever happens first. As soon as the educator 106 provides the response, the system finalizes the loop process that monitors that the child care business 102 receives a response before the due date. If the educator 106 does not respond before the due date, the process moves to block 1908.

At block 1908, it is determined if the number of hours in the service date minus the due date is less than 24 hours. If the answer is no, the process moves to block 1910, wherein a message is sent to the user indicating the Educator is unresponsive. If the answer is yes, the process moves to block 1912, wherein a message is sent to the user indicated that the Educator is unresponsive and to contact the Emergency Help Desk.

Returning to block 1914, if the Educator responds to the service request, it is determined in block 1916 whether the request is accepted. If the request is not accepted the process moves to block 1918, wherein a message is sent to the user indicating the same. If the request is accepted, the process moves to block 1920, wherein the Educator's Availability Calendar is updated to reflect the now unavailable spots, and a message is sent to the user, block 1922.

Any user in the system with a Service Request (Child Care Business, Parents or Educators) have access to their list of requests. Parents and Child Care Businesses will see the list of Services requests that they have launched, the date when it was requested, the due date, details of the request (as per the parameters listed before) and the status (Pending, accepted, rejected, unresponsive). Child Care Business and Educators will have access to the list of Service Requests that they have received, the date when they received it, the due date (if it has not been yet responded), details of the request and the status. Any user will be able to filter their list based on any of the previous characteristics. For example, a Child Care Business can filter the requests that have been accepted and order them by date. Child Care Businesses, Educators and Parents will be also able to set up alerts in the system so that they receive reminders based on when the Child Care Services or Educators Services have been booked.

Once the engagement between the two parties (Child Care Business and Parent or Child Care Business and Educator) has been confirmed, any of the users that have committed may decide to modify it. The following examples reflect some of the possible scenarios: The Parent user decides to modify the dates when the Child Care Services will be required; the number of children that will require Child Care Services is changed; and Educator decides to cancel the request because they are no longer available to provide the support. Any modification to the service request, regardless of who initiates the change, will have to be validated by the two parties involved.

When a modification request is launched by any of the two users involved, a new Service request will be created in the database. This new Service Request will be linked to the original one (Child Care Service or Educator Service) and the status will be “pending validation” until it is confirmed by the second party. If any of the parties rejects the request for modification, it will be rejected and the original Service Request that was accepted will prevail.

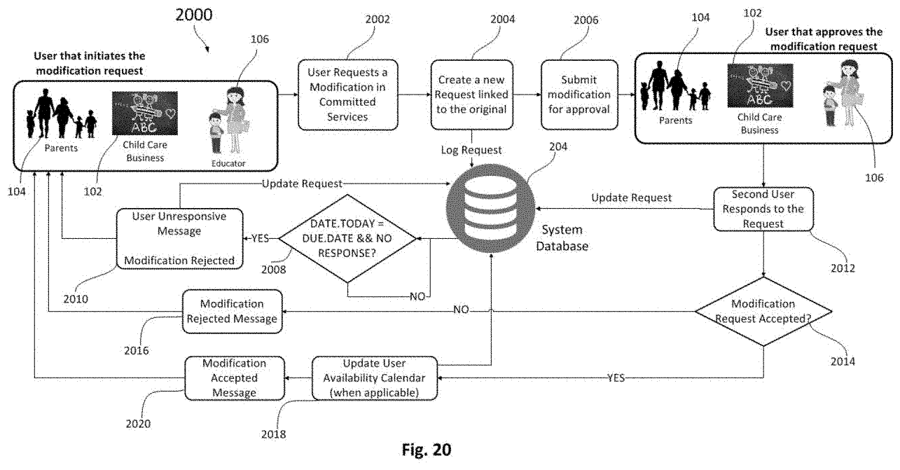

Turning now to FIG. 20, there is illustrated a process-flow diagram 2000 of a user service modification request. At block 2002, a first party user (102, 104, 106) launches a service modification request including all information required to modify the existing service request, and then submits the request. At which point the process moves to block 2004, wherein a new service request is created and linked to the prior service request to which the requested modification pertains. And this information is updated in database 204. At block 2006, the medication request is sent to the second party user that is affected by the modification request (i.e., Parent 104, Child Care Business 102, or Educator 106).

After the request is sent, the process determines if the second party user responds before the due date submitted by the first party user making the modification request. At block 2008 it is determined whether the current date is equal to the due date set by the first party user in the service request and whether the second party user has responded. The process loops at block 2008 until the second party user provides a response or until the due date is reached, whichever happens first. As soon as the second party user provides the response, the system finalizes the loop process that monitors that the first party user receives a response before the due date. If the second party user does not respond before the due date, the process moves to block 2010, wherein a message is sent to the first party user that the second party user is unresponsive, and the modification request is rejected.

Returning to block 2012, if the second party user responds to the service modification request, it is determined in block 2014 whether the request is accepted. If the request is not accepted the process moves to block 2016, wherein a message is sent to the user indicating the same. If the request is accepted, the process moves to block 2018, wherein the User's Availability Calendar is updated as applicable to reflect the service request change, and a message is sent to the first party user, block 2020.

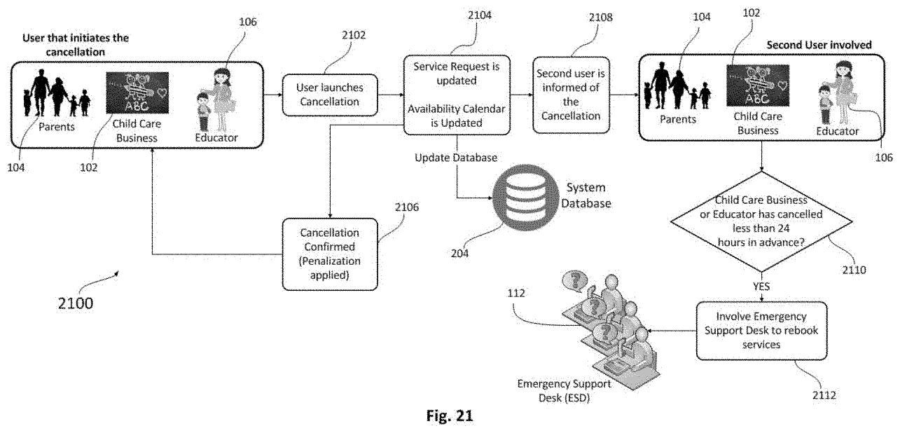

Turning now to FIG. 21, there is illustrated a process-flow diagram 2100 of a user service cancelation request. At block 2102, the first party user (102, 104, or 106) canceling a service request launches the cancel service request and submits the cancelation request. At block 2104 the database 204 is updated to reflect the canceled service, and if applicable, the Availability Calendar of the second party user is updated to reflect the cancelation. At block 2106, the cancelation is confirmed with the first party user and if applicable, the first party user is penalized. At block 2108, the second party user (102, 104, 106) is notified of the cancelation. At block 2110 it is determined whether the cancelation was made within 24 hours of the scheduled service. If the answer is yes, at block 2112 a message is sent to contact the Emergency Support Desk 112, which will be Emergency Support Desk will be involved to support the affected user to rebook the necessary services with a different Child Care Business/Educator as quickly as possible.

For those cases in which the Child Care Services or Educator Services are required within less than 24 hours, the Front-Office users (Child Care Businesses and Parents, in this case) will be supported by the Emergency Support Desk (ESD).

This Emergency Support Desk will have the ability to access the profile of the user that is requesting the last-minute services and filter the available Child Care Businesses or Educators in the database to meet the criteria specified in the Service Request information and in the user's profile preferences.

In this embodiment of the invention the Emergency Service Desk will be dimensioned so that any Emergency request is acknowledge in less than 1 hour and the services booking is finalized in less than 3 hours. In the event that there is no available Child Care Businesses or Educators that meet the characteristics and availability specified by the user, the Emergency Support Desk will contact the user immediately to define different alternatives to fulfill their Service request.

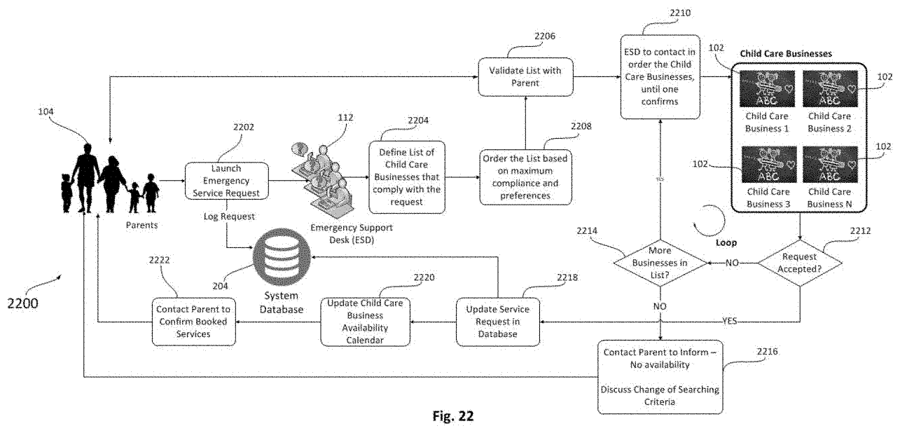

With reference to FIG. 22, there is illustrated a process-flow diagram 2200 of an emergency service request. For those cases in which the child care services or educator services are requires within less than 24 hours, child car business or parents will be supported by the Emergency Support Desk (ESD).

The diagram of FIG. 22 represents an engagement of a parent 104 with a child care business 102 through the ESD 112. However, the process shown in FIG. 22 and described herein can also be used for the engagement of a child care business with educators.

As shown in FIG. 22, parents 104 that require childcare services in less than 24 hours will have the chance to create a ticket, block 2202, with the Emergency Support Desk 112 through the platform and launch an Emergency Service Request. The Emergency Support Desk 112 will get this request and will have the ability to access the profile of the user, block 2204, that is requesting the last-minute services and filter the available child care businesses in the database to meet the criteria specified in the service request information and in the user's profile preferences.

There might be several child care businesses that meet the criteria defined by the parents 104 so once the ESD 112 defines the list of child care businesses that comply with the requirements, they will prioritize this list based on the user's profile preferences, block 2208, and will present this list to the first user for their validation and confirmation, block 2206. During the validation, the first user can edit the list by removing items on the list. Once the user confirms that this list is correct, the Emergency Support Desk 112 will contact, one by one, each of the child care businesses, blocks 2210, 2212 and 2214, in the list until they get confirmation about the availability and commitment to providing the required services. As soon as one of the child care businesses in the list confirm that they will provide the services, the Emergency Support Desk 112 will update the request with the information of the business that has been engaged, block 2218. They will also update the availability schedule of that specific child care business 102, block 2220, on the committed services and they will communicate back with the first user (Parent or Child Care Business) to confirm that their last-minute request has been fulfilled and the services have been committed accordingly, block 2222.

In this embodiment, the Emergency Service Desk 112 will be dimensioned so that any Emergency request is acknowledged in less than 1 hour and the services booking is finalized in less than 3 hours.

If there is no available child care businesses that meet the characteristics and availability specified by the user, the Emergency Support Desk 112 will contact the user immediately to define different alternatives or search criteria in order to fulfill their Service request.

Finally, it's also worth noting that only Parents with the “Parent Information Form” completed will have access to this service. The Emergency Service Desk will confirm that this information has been properly completed and will contact back the parents if this information is still pending.

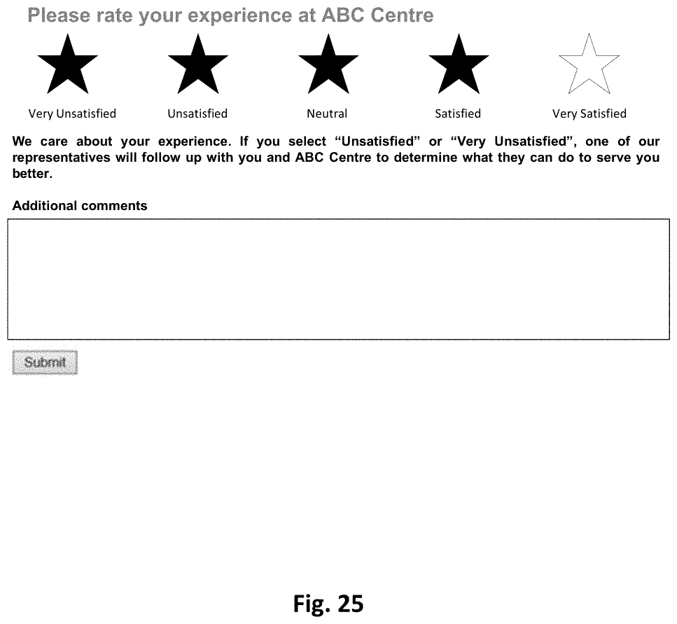

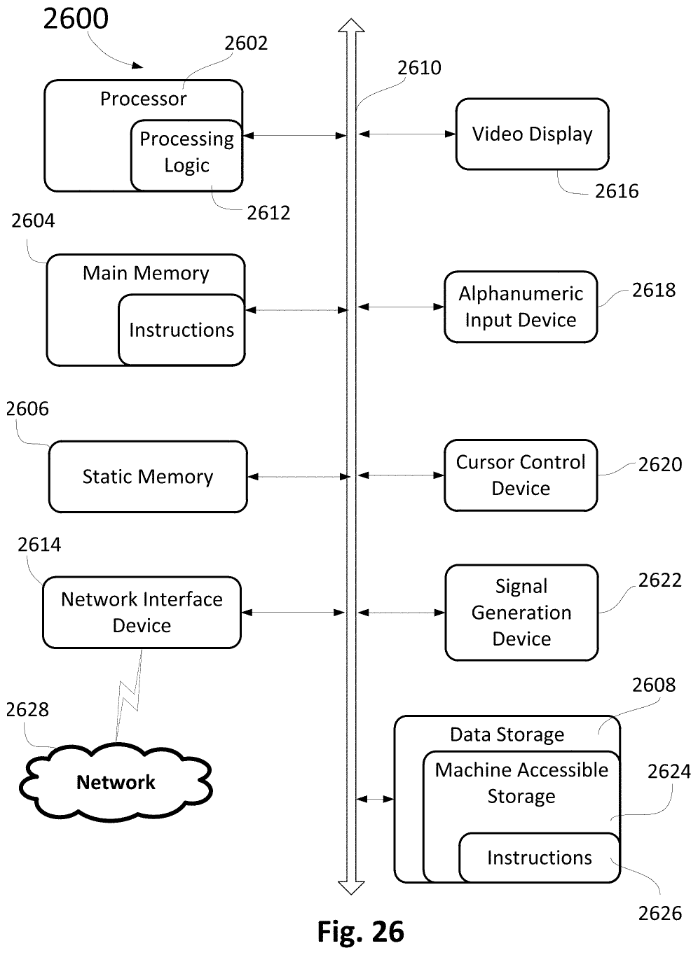

Any cancellation or modification of Emergency Service requests will be like the process described above with the exception that it will have to be performed exclusively by the Emergency Support Desk. Therefore, the users will have to contact the ESD and manage any change through them. The workflow associated with modifications and cancelations are depicted in FIGS. 25 and 26.

If a user requires a modification to a Committed Services with less than 24 hours in advance, the user will have to contact the Emergency Support Desk (ESD) and the modification will be managed as shown in FIG. 25.

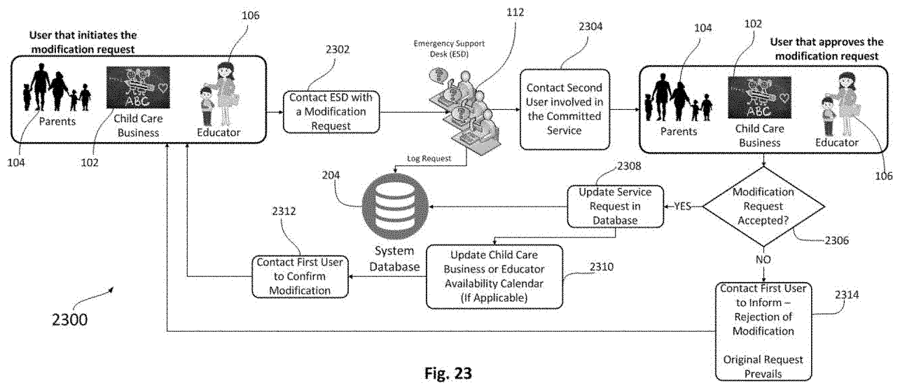

With reference to FIG. 23, there is illustrated a process-flow diagram 2300 of an emergency service modification request. At block 2302 at first party user (102, 104, 106) requiring a modification of service within 24 hours of the scheduled service contacts the Emergency Support Desk 112 and informs the support desk of the required changes. The support desk updates the database 204 to reflect the requested changes and then at block 2304 contacts the affected second party user (102, 104, 106) regarding the requested service modification. At block 2306 it is determined if the modification request is accepted. If the answer is yes, then the database 204 is updated, block 2308, the Availability Calendars are updated as required, block 2310, and then a message is sent to the first party user that confirms acceptance of the modification, block 2312. If at block 2306 the answer is no, at block 2314 the first party user is contacted by the support desk 112 to advise that the modification request was not accepted.

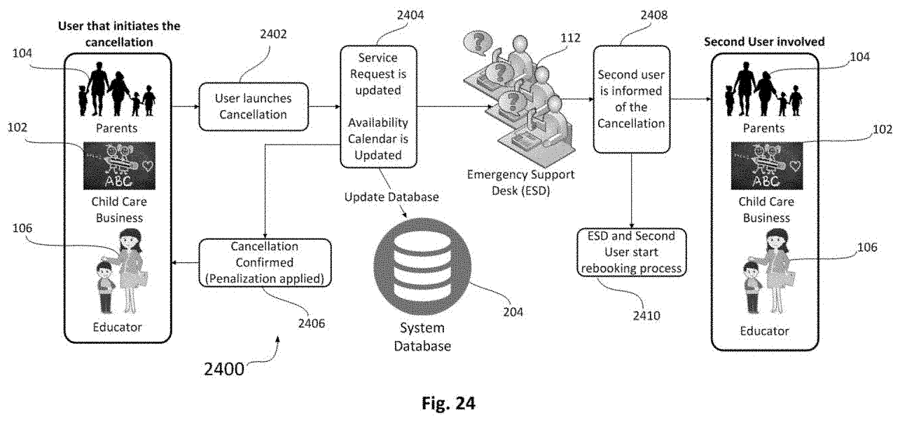

With reference to FIG. 24, there is illustrated a process-flow diagram 2400 of an emergency service cancelation request. At block 2402, the first party user (102, 104, 106) that is canceling the emergency service request submits the cancelation request. At block 2404 the database is updated to reflect the cancelation and the Availability Calendars are updated as required. At block 2406 a confirmation message is sent to the first party user and if applicable, the first party user is penalized. The Emergency Support Desk 112 is notified of the cancelation and at block 2408 the support desk contacts the affected second party user (102, 104, 106) to notify the user of the cancelation and then at block 2410 works with the second party user to help find a replacement for the canceled service.

Once the committed Child Care Services or Educator Services are fulfilled, the users will have the option to provide feedback and score their experience. Only users that have booked services through the system will have the option to provide feedback and score.

The User Experience Rating and Feedback method is essential to every user in the system. The ratings and feedback provided by the users will encourage the Child Care Businesses and Educators to continuously improve their services. In addition, this User Experience and Feedback method will provide the invention with a framework that will ensure the highest quality standards and to minimize/eliminate the abuse of the services offered in the platform. A representation of the User Experience Rating and Feedback Interface is shown in FIG. 25.

The Child Care Business will be rated by two different type of users: Parent and Educators. The Parents will rate the Child Care Businesses based on the quality of their Child Care Services and interactions. The Educators will rate the Child Care Businesses based on their experience as an employee. Therefore, since the two types of users are rating different factors, in order to avoid mixed and incongruent feedback and scoring, the Child Care Businesses will have two separate set of ratings: One for the Parents and one for the Educators. On the contrary, the Educators will just have one Experience rating.

In existing rating systems, the method to calculate the rating associated to a service is measured based on the average value of the different votes of the users. The problem with this approach is that fake users that create a profile just to have the chance to vote favorably or unfavorably will have a significant impact in the calculation of the average.

In embodiments of the invention, to minimize the impact of any fake users, the votes will be weighted so that the most experienced users will have a higher weight than novice users. The more engagements and Service Requests, the more experience the users will have, the more trustworthy they will be and therefore the more weight in the score calculation they will have.

To separate true users of the system from less frequent users, the Parent Experience Rating system internally classifies each User into different levels: Gold, Silver, or Bronze. When a user first creates their profile they will have a Bronze level. The more they engage in transactions within the platform, they will increase the status and be transferred to higher levels.

In addition, a user that used the system very frequently and then stopped using the system should not maintain the Gold or Silver status if they are no longer using the platform. As a result, the level of the users will be calculated based on the number of transactions that have been performed in the last 12 months. By looking at a 12-month window, we guarantee that users won't be abruptly demoted to the lowest level but gradually demoted or promoted according to their actual engagement in the recent past.

In embodiments, the conditions required to reach the different levels are: Bronze—the user has at least one transaction completed during the qualifying period (12 months in this example); Silver—the user has at least X transactions completed during the qualifying period; and Gold—the user has at least 2.5× transactions completed during the qualifying period. Where X is a parameter that will be defined by the Office Administrator. Continuous testing and improvement of the User Experience Rating system will require the fine tuning of the value of this parameter.

Once the level has been defined, the weight in the scoring algorithm will be defined as follows: Gold Level Weight (GLW)=60%; Silver Level Weight (SLW)=30%; and Bronze Level Weight (BLW)=10%.

The percentages detailed before are just examples of the weights that could be use in this algorithm. The patent should claim any other representation of the invention in which the percentages differ from these ones. The only fixed restriction will be as follows: GLW+SLW+BLW=1.

Finally, in this representation of the invention, the formula that will be used to calculate the score associated to a user will be the following:

$$User Score = ( \frac{\sum Gold Level Scores}{Number of Gold Users} ) \cdot GLW + ( \frac{\sum Silver Level Scores}{Number of Silver Users} ) \cdot SLW + ( \frac{\sum Bronze Level Scores}{Number of Bronze Users} ) \cdot BLW$$

The difference of the average and the proposed algorithm are demonstrated by using an example. 10 Gold members completed transactions with ABC Center, 7 of them rate the service as “Very Satisfactory” (5 stars), and 3 of them rate the service as “Satisfactory” (4 starts). 15 Silver members completed transactions with ABC Center. 8 of them rate the service as “Very Satisfactory” (5 stars), and the other 7 rate the service as “Satisfactory” (4 stars) 25 Bronze members completed transactions with ABC Center. And 15 of them rate the service as “Satisfactory” (4 stars), 5 as “Neutral” (3 stars), and 5 rate the service as “Very Unhappy” (1 star).

Case A—Using Simply the Average:

$$User Score = ( \frac{\sum Scores}{Number of Gold Users} ) = ( \frac{( 7 + 8 ) \cdot 5 + ( 3 + 7 + 15 ) \cdot 4 + 5 \cdot 3 + 5 \cdot 1}{50} ) = 3.9$$

Case B—Using the Rating Method of the Present Invention:

$$User Score = ( \frac{\sum Gold Level Scores}{Number of Gold Users} ) \cdot GLW + ( \frac{\sum Silver Level Scores}{Number of Silver Users} ) \cdot SLW + ( \frac{\sum Bronze Level Scores}{Number of Bronze Users} ) \cdot BLW$$

$$User Score = ( \frac{7 \cdot 5 + 3 \cdot 4}{10} ) \cdot 0.6 + ( \frac{8 \cdot 5 + 7 \cdot 4}{15} ) \cdot 0.3 + ( \frac{15 \cdot 4 + 5 \cdot 3 + 5 \cdot 1}{25} ) \cdot 0.1 = 2.82 + 1.36 + 0.32 = 4.5$$

In Case B, the impact of people that have used the platform just a few times is not as critical as in Case A. It is also worth noting that the rating is not a fixed number, but it is dynamically calculated value. That means that the score is recalculated every time that a new rate is provided by a user, taking in consideration the levels (and thus weights) that each user has at that moment. In addition to the score calculations presented in the previous section, users can also provide feedback and comments about the quality of the received services.

Each rating will have a score (from 1 to 5 stars) and a comment associated to that score. In the comments section the user should clearly indicate the reasons, both positive or negative, that made him/her provide that rating. Feedback and score have a subjective component and therefore the user that has been evaluated will always can respond to any feedback (positive, neutral or negative). This response will provide some perspective to any other user (Parent, Educator or Child Care Business) that is reviewing previous experiences of other users.

With reference to FIG. 26, there is diagrammatically illustrated the architecture of a computer 2600 that may be used within the system 100, for example, as one or more of the user computers (e.g., one of the computing devices 202, 204, 206, 208, 210, 212, 214, 216, 218, shown in FIG. 2). In exemplary embodiments, the computer 2600 may be suitable for use as a computer within the context of the System 100 that is configured to operationalize managing scheduling and booking child care services, user profiles, and user interaction within system 100. In particular embodiments, the computer 2600 may be connected (e.g., networked) to other computers in a LAN, an intranet, an extranet, and/or the Internet. As noted above, the computer 2600 may operate in the capacity of a server or a client computer in a client-server network environment, or as a peer computer in a peer-to-peer (or distributed) network environment. The computer 2600 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 2600 includes a processing device 2602, a main memory 2604 (e.g., read-only memory (ROM), flash memory, dynamic random access memory (DRAM) such as synchronous DRAM (SDRAM) or Rambus DRAM (RDRAM), etc.), a static memory 2606 (e.g., flash memory, static random access memory (SRAM), etc.), and a data storage device 2608, which communicate with each other via a bus 2610.

The processing device 2602 represents one or more general-purpose processing devices such as a microprocessor, a central processing unit, or the like. More particularly, the processing device 2602 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 2602 may also be one or more special-purpose processing devices such as an application specific integrated circuit (ASIC), a field programmable gate array (FPGA), a digital signal processor (DSP), network processor, or the like. The processing device 2602 may be configured to execute processing logic 2612 for performing various operations and steps discussed herein.

The computer 2600 may further include a network interface device 2614. The computer 2600 also may include a video display unit 2616 (e.g., a liquid crystal display (LCD) or a cathode ray tube (CRT)), an alphanumeric input device 2618 (e.g., a keyboard), a cursor control device 2620 (e.g., a mouse), and a signal generation device 2622 (e.g., a speaker). The data storage device 2608 may include a non-transitory computer-readable storage medium 2624 (also known as a non-transitory computer-readable storage medium or a non-transitory computer-readable medium) on which is stored one or more sets of instructions 2626 (e.g., software, software modules) embodying any one or more of the methodologies or functions described herein. The software 2626 may also reside, completely or at least partially, within main memory 2604 and/or within processing device 2602 during execution thereof by computer 2600—main memory 2604 and processing device 2602 also constituting computer-accessible storage media. The software 2626 may further be transmitted or received over a network 2628 via network interface device 2614.

While the computer-readable storage medium 2624 is shown in an exemplary embodiment to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding or carrying a set of instructions for execution by the computer and that cause the computer to perform any one or more of the methodologies of the present invention. The term “computer-readable storage medium” should accordingly be understood to include, but not be limited to, solid-state memories, optical and magnetic media, etc.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A computer-implemented data processing method for scheduling child care services in real-time, the data processing method comprising:
receiving, by one or more computer processors, a command to create an electronic record for a child care service by a first user;
creating, by one or more computer processors, an electronic record for the child care service and digitally storing the record;
receiving, by one or more computer processors, child care service data input by the first user, wherein the child care service data comprises each of:
identification of a second user;
time and date of child care service; and
a response due date;
processing, by one or more computer processors, the child care service data by electronically associating the child care service data with the record for the child care service;
digitally storing, by one or more computer processors, the child care service data in association with the child care service record;
creating, by one or more computer processors, based at least in part on the received child care service data, an availability data record of the second user;
processing, by one or more computer processors, the availability data record of the second user by electronically associating the availability data record of the second user to the record for the child care service;
determining, by one or more computer processors, based at least in part on the received child care service data and the availability data record of the second user, whether child care services are available by the second user and creating a message flag based on the determination; and
sending, by one or more computer processors, an electronic message, based at least in part on the message flag, to the first user.

2. The computer-implemented data processing method of claim 1, wherein the message flag indicates that child care services are available by the second user.

3. The computer-implemented data processing method of claim 1, wherein the message flag indicates that child care services are not available the second user.

4. The computer-implemented data processing method of claim 1, wherein the message flag indicates a non-response by the second user within a predetermined time calculated by the response due date.

5. The computer-implemented data processing method of claim 1, wherein the first user is a parent or guardian user and the second user is a child care business.

6. The computer-implemented data processing method of claim 1, wherein the first user is a child care business and the second user is an educator.

7. The computer-implemented data processing method of claim 1, further comprising:
receiving, by one or more computer processors, a request to modify the child care service data; and
in response to receiving the request, determining, by one or more computer processors, whether the child care service data is modifiable.

8. The computer-implemented data processing method of claim 7, further comprising:
in response to determining that the child care service data is modifiable, modifying, by one or more computer processors, the child care service data.

9. The computer-implemented data processing method of claim 7, further comprising:
in response to determining that the child care service data is not modifiable, electronically sending a message to the first user that the child care service data is not modifiable.

10. The computer-implemented data processing method of claim 1, further comprising:
receiving an electronic confirmation that child care services, made according to the child care service data and the availability data record, has been scheduled;
in response to receiving the electronic confirmation, updating the child care service record and the availability data record to reflect that child care services have been scheduled.

11. The computer-implemented data processing method of claim 1, further comprising:
receiving an electronic confirmation that child care services, made according to the child care service data and the availability data record, has been completed;
receiving, by one or more computer processors, child care service quality data input by the first user, wherein the child care service quality data comprises a rating indicator of the child care services performed by the second user;
digitally storing, by one or more computer processors, the child care services quality data in association with the electronic record for the child care services;
electronically determining a weighting factor for the rating indicator, by one or more computer processors, that is based at least in part on a number of times the first user has completed child care services; and
in response to determining a weighting factor, modifying, by one or more computer processors, a profile record of the second user to reflect the weighting factor.
